(19) United States
(12) Patent Application Publication
(10) Pub. No.: US 2001/0015393 A1
(43) Pub. Date: Aug. 23, 2001

(54) WINDING APPARATUS

(76) Inventors: HIROSHI MIYAZAKI, TOYOTA-SHI (JP); TETSUYA MIURA, NISHIKAMO-GUN (JP)

Correspondence Address: OLIFF & BERRIDGE, P O BOX 19928, ALEXANDRIA, VA, 22320

(21) Appl. No.: 09/253,517

(22) Filed: Feb. 19, 1999

(30) Foreign Application Priority Data
Jul. 13, 1998 (JP) 10-197002
Feb. 24, 1998 (JP) 10-42433
Nov. 27, 1998 (JP) 10-336428

(51) Int. Cl. B21F 3/04; H01F 41/06

(52) U.S. Cl. 242/437.3; 242/447

(57) ABSTRACT

A winding apparatus is capable of winding an element wire at a predetermined winding position on winding portions with good alignment of windings by defining the winding positions of the element wire on its winding progress side, regardless of variation of the predetermined winding positions. The element wire is guided to winding positions for the first winding layer on a winding frame, by moving a box member to a position apart from the turn immediately previously formed on the frame, by an amount equal to the diameter of the wire in the direction of winding progress along the axis of the winding frame. While this positioning is maintained, an element wire supplying reel is revolved around the winding frame, and thereby pays out the element wire. Therefore, the element wire is guided to the predetermined winding position defined by the box member and the previously formed turn, and the wire is wound at the winding position. For the second winding layer, the element wire is guided to predetermined winding positions, by moving the box member to a position apart from the previously formed turn, by an amount equal to the diameter of the wire in the direction of winding progress for the second layer. The winding position is defined by the box member and the winding sandwiching the position for the winding of each layer, so that the element wire can be wound at the predetermined winding positions with good alignment.

### INCORPORATION BY REFERENCE

The disclosure of Japanese Patent Application Nos. HEI 10-42433 filed on Feb. 24, 1998, HEI 10-197002 filed on Jul. 13, 1998, and HEI 10-336428 filed on Nov. 27, 1998, each including the specification, drawing and abstract, are incorporated herein by reference in their entirety.

### BACKGROUND OF THE INVENTION

1. Field of Invention

The present invention relates to a winding apparatus for winding an element wire on a winding portion and, more particularly, to a winding apparatus that automatically winds an element wire around a winding portion, for example, a magnetic core, in a precise wire alignment.

2. Description of Related Art

Various coils are known which are formed by winding a wire around a magnetic core, for example, coils formed around magnetic cores in transformers, electric motors and the like. The performance of such an electric device (e.g., a transformer, or an electric motor) can be enhanced by increasing the coil winding density (i.e., space factor). In other words, a smaller-size and higher-performance device can be obtained by winding a wire in good alignment with less of a gap between turns.

Japanese Patent Application Laid-open No. SHO 64-43046 describes a winding apparatus for automatically winding an element wire in good alignment. In this related technology, a pair of coil wire guide members are individually moved in a direction of a coil axis. After a first turn of the element wire around a winding portion, an upper one of the guide members is moved one pitch parallelly to the coil axis. Subsequently, the element wire, guided by the upper guide member, is wound over a half of the periphery of the winding portion. The other guide member is then parallelly moved one pitch to guide the element wire for the winding over the other half of the periphery of the winding portion. In this manner, while the coil wire is being wound over a half of the periphery of the winding portion, the position of the wire on the other half is restricted by the corresponding guide member. Thus, the element wire is progressively wound around the winding portion while the wire is aligned for every turn.

However, according to the technology described in the aforementioned laid-open patent application, each guide member is designed to guide an element wire only on one side in a direction of the diameter of the wire (that is, a direction of the axis of the winding portion). Therefore, a force needs to be applied to the element wire in that direction along the axis of the winding portion in order to align turns of the wire. It is also necessary to offset the element supplying position from a predetermined wire placing position on the winding portion, in the direction of the axis. As a result, the construction of the winding apparatus is likely to become complicated.

Moreover, in the winding apparatus described in the aforementioned laid-open patent application, the turn or pitch shift of the element wire is performed at a position where a first turn of the wire around the winding portion ends and the second turn starts. In some cases, however, a wound portion of the wire lifts off in a direction of the diameter of the winding portion so that a portion of the wire corresponding to the start position of the second turn is wound over a starting portion of the first turn of the wire. In some other cases, a portion of the element wire wound immediately before a turn shift deviates from a prescribed winding position due to the turn shift, and this deviation adversely affects the next and later turns. Such deviation may result in the last turn wound over the immediately previous turn of the wire, so that a deviation continues into the second and later layers of winding. As a result, the degree of alignment of the winding and the space factor of the winding may decrease to undesired levels.

### SUMMARY OF THE INVENTION

Accordingly, it is an object of the present invention to prevent a reduction of the space factor of coil winding by aligning an element wire at a predetermined winding position, without requiring a complicated construction of a winding apparatus.

To achieve the objects of the invention, a first aspect of the invention provides a winding apparatus for winding an element wire around a winding portion, including a supplier that supplies the element wire, a guide that guides the element wire to a predetermined winding position, a controller that, in a winding layer around the winding portion, defines the predetermined winding position of the element wire guided by the guide, on a side of the element wire, the side facing in a direction of winding progress along an axis of the winding portion, and a mover that moves the controller synchronously with a movement of the predetermined winding position.

According to this aspect of the invention, the winding position on the winding portion is defined on the winding progress side by the controller, and on the opposite side by the winding wound around the winding portion, for any layer of winding. Thus, the element wire can be positioned on its two opposite sides. Furthermore, since the controller is moved following the winding position, the element wire is positioned on its opposite sides at every predetermined winding position, so that winding at predetermined winding positions can be precisely performed.

A second aspect of the invention provides a winding apparatus for winding an element wire around a winding portion, including a supplier that supplies the element wire, a guide that guides the element wire to a predetermined winding position on the winding portion, a winder that winds the element wire at the predetermined position, and restricting members provided in the guide so that the restricting members sandwich the predetermined position and face each other in a direction of an axis of the winding portion, an interval between the restricting members being substantially equal to a width of the element wire. The element wire passes between the restricting members.

According to this aspect of the invention, the guide is provided with the restricting members for sandwiching the predetermined position while facing each other in a direction of an axis of the winding portion, with an interval therebetween being substantially equal to a width of the element wire. Since the element wire passes through a gap between the restricting members, the element wire is restricted in position from its opposite sides while being guided to the predetermined winding position. Therefore, the element wire can be precisely wound at predetermined winding positions, regardless of the position of the element wire supplier in a direction of a winding axis relative to the winding portion.

A third aspect of the invention provides a winding apparatus for winding an element wire around a winding portion, including a reel that carries a winding wound around an axis substantially parallel to an axis of the winding portion, and a winder that winds the element wire at a predetermined position on the winding portion, wherein a winding direction of the element wire wound around the reel is the same as a winding direction of the element wire wound by the winder.

In this aspect, since the direction of revolution and the direction of rotation of the element wire supplying reel for winding the element wire are the same, the element wire has a spring-back (a reverse curvature needed for tight contact with the winding portion) when wound on the winding portion. Therefore, tight contact of windings with the winding portion can be achieved without requiring a complicated device.

A fourth aspect of the invention provides a winding apparatus for winding an element wire around a winding portion, including a supplier that supplies the element wire, a controller that revolves the supplier around the winding portion, and a rotating member which is disposed within a range of revolution of the supplier around the winding portion, and which is rotated by the controller in a phase different from a phase of the supplier.

In this aspect, the operation of the rotating member disposed within a range of revolution of the supplier around the winding portion and, at the same time, between the supplier and the predetermined winding position, is performed in a phase different from the phase of the element wire supplying operation, so that an operation other than the winding operation can be constantly performed at timing different from the timing of the winding operation, at a given position on the winding portion. Therefore, the two operations do not interfere with each other, but can be precisely performed.

A fifth aspect of the invention provides a winding apparatus for winding an element wire around a winding portion, including a supplier that supplies the element wire, a guide which protrudes from an outward point toward an inward point in an approaching direction to an outer peripheral surface of the winding portion, and which guides the element wire to a predetermined winding position on the winding portion, a circumferential mover that moves the guide in a direction substantially perpendicular to the axis of the winding portion, and a axial mover that moves the guide in a direction of the axis of the winding portion.

In this aspect, the guide can be moved substantially freely over the outer periphery of the winding portion, so that the winding position can be constantly defined at any position on the winding portion, regardless of the shape of the winding portion.

### BRIEF DESCRIPTION OF THE DRAWINGS

The foregoing and further objects, features and advantages of the present invention will become apparent from the following description of preferred embodiments with reference to the accompanying drawings, wherein like numerals are used to represent like elements and wherein:

FIG. 1 is a schematic side view of a winding apparatus according to a first embodiment of the invention;

FIG. 2 is a schematic elevational view of the winding apparatus according to the first embodiment;

FIG. 3 is an enlarged view of a winding alignment mechanism shown in FIG. 1;

FIG. 4 is a sectional view taken on line 4-4 in FIG. 3;

FIGS. 5 through 22 illustrate an operation of winding a wire according to the first embodiment;

FIG. 23 illustrates a winding operation according to a second embodiment of the invention;

FIG. 24 is a view of a winding apparatus shown in FIG. 23, viewed in a direction indicated by arrow A in FIG. 23;

FIG. 25 illustrates a relationship between a winding frame and a position defining roller of the winding apparatus that are shown in FIG. 24;

FIG. 26 is a view of the position defining roller and an element wire, viewed in a direction indicated by an arrow X in FIG. 25;

FIGS. 27 through 29 illustrate the winding operation according to the second embodiment of the invention;

FIG. 30 is a side plate drive mechanism according to a third embodiment of the invention;

FIGS. 31 and 32 illustrate how the side plate drive mechanism move the side plates;

FIGS. 33 through 35 illustrate winding operations according to the third embodiment;

FIG. 36 shows a side sectional view of a winding apparatus according to a fourth embodiment of the invention;

FIG. 37 shows a horizontal sectional view taken on line 37-37 in FIG. 36;

FIG. 38 shows a vertical sectional view taken on line 38-38 in FIG. 36;

FIG. 39 is an enlarged view of a core mounting portion shown in FIG. 36;

FIG. 40 is a horizontal sectional view of the core mounting portion, viewed in a direction indicated by line 40-40;

FIG. 41 is a vertical sectional view of the core mounting portion, viewed in a direction indicated by line 41-41;

FIG. 42 is a vertical sectional view of the core mounting portion, viewed in a direction indicated by line 42-42;

FIG. 43 is a vertical sectional view of the core mounting portion, viewed in a direction indicated by line 43-43;

FIG. 44 is a vertical sectional view of the core mounting portion, viewed in the same direction as in FIG. 42, after the winding is completed;

FIG. 45 illustrates the winding completed according to the fourth embodiment;

FIGS. 46 and 47 illustrates the winding operation according to the fourth embodiment;

FIG. 48 is a view of a divided core according to the fourth embodiment, viewed from a coil end-side;

FIG. 49 is a sectional view of the divided core taken on line 49-49 in FIG. 48;

FIG. 50 shows the configuration of a winding-start lead portion of an element wire according to a fifth embodiment of the invention;

FIG. 51A illustrates the arrangement of component units and portions of a winding apparatus according to the fifth embodiment, when the formation of the winding-start lead portion is about to start;

FIG. 51B is a view of the arrangement shown in FIG. 51A, viewed in a direction indicated by an arrow B in FIG. 51A;

FIG. 52A illustrates the configuration of a winding frame according to the fifth embodiment;

FIG. 52B is a view of the winding frame, viewed in a direction indicated by an arrow B in FIG. 52A;

FIG. 52C is a view of the winding frame, viewed in a direction indicated by an arrow C in FIG. 52A;

FIG. 53A shows the configuration of an odd number-layer aligning cup in the fifth embodiment;

FIG. 53B is a view of the odd number-layer aligning cup taken in a direction indicated by arrow B in FIG. 53A;

FIG. 54A shows the configuration of an odd number-layer aligning cup in the fifth embodiment;

FIG. 54B is a view of the odd number-layer aligning cup taken in a direction indicated by arrow B in FIG. 54A;

FIG. 55A shows the configuration of an even number-layer aligning cup in the fifth embodiment;

FIG. 55B is a view of the even number-layer aligning cup taken in a direction indicated by arrow B in FIG. 55A;

FIG. 56A shows the configuration of an even number-layer aligning cup in the fifth embodiment;

FIG. 56B is a view of the even number-layer aligning cup taken in a direction indicated by arrow B in FIG. 56A;

FIG. 57A shows the construction of main shafts and a winding frame in the fifth embodiment;

FIG. 57B is a view of a main shaft taken in a direction indicated by line 57B-57B in FIG. 57A;

FIG. 58 illustrates the arrangement of component units of the winding apparatus of the fifth embodiment, for forming a winding-start lead portion;

FIG. 59A illustrates the arrangement of component units of the winding apparatus of the fifth embodiment, for attaching the winding-start lead portion to the winding frame;

FIG. 59B is a plan view of a winding unit shown in FIG. 59A;

FIG. 60 is a view of the winding unit taken in a direction indicated by 60 in FIG. 59A;

FIG. 61A illustrates the start of winding for the first layer according to the fifth embodiment;

FIG. 61B illustrates the FIG. 62 illustrates the winding operation for the first layer according to the fifth embodiment;

FIG. 63 illustrates the winding operation for the second layer according to the fifth embodiment;

FIG. 64 illustrates the arrangement of the component units of the winding apparatus of the fifth embodiment when the winding operation is completed;

FIG. 65 illustrates the arrangement of the component units of the winding apparatus of the fifth embodiment, for cutting the element wire after the winding operation is completed;

FIG. 66 shows the configuration of a coil produced by the winding apparatus of the fifth embodiment;

FIG. 67A shows the configuration of a winding frame in a sixth embodiment of the invention;

FIG. 67B is a view of the winding frame taken in a direction indicated by arrow B in FIG. 67A;

FIG. 67C is a view of the winding frame taken in a direction indicated by arrow C in FIG. 67A;

FIG. 68A illustrates the construction of a main shaft in the sixth embodiment;

FIG. 68B is a view of the main shaft taken in a direction indicated by arrow B in FIG. 68A;

FIG. 69A shows the configuration of a coil holder in the sixth embodiment;

FIG. 69B is a view of the coil holder taken in a direction indicated by arrow B in FIG. 69A;

FIG. 69C is a view of the coil holder taken in a direction indicated by arrow C in FIG. 69A;

FIG. 70 illustrates the construction of an adapter in the sixth embodiment;

FIG. 71 illustrates a situation where the last layer winding is completed by the winding apparatus of the sixth embodiment;

FIG. 72 illustrates an operation of fitting the coil holder to the right-side main shaft in the winding apparatus of the sixth embodiment;

FIG. 73 illustrates an operation of placing the coil holder so as to cover the coil in the winding apparatus of the sixth embodiment;

FIG. 74 illustrates an operation of cutting the element wire at the coil terminal end in the winding apparatus of the sixth embodiment; and

FIG. 75 illustrates an operation of removing the coil in the winding apparatus of the sixth embodiment.

### DETAILED DESCRIPTION OF PREFERRED EMBODIMENTS

Preferred embodiments of the present invention will be described in detail hereinafter with reference to the accompanying drawings.

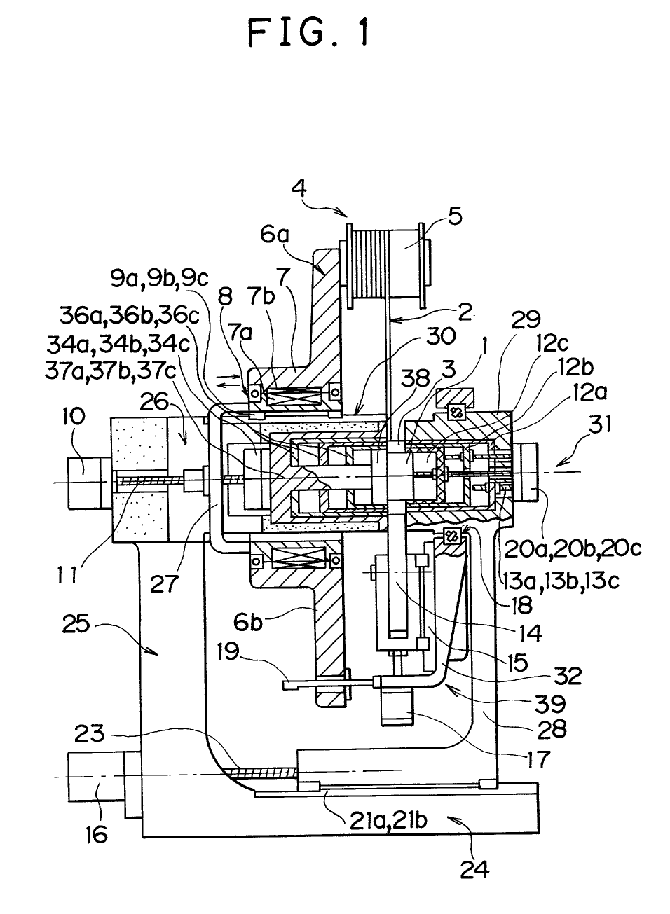

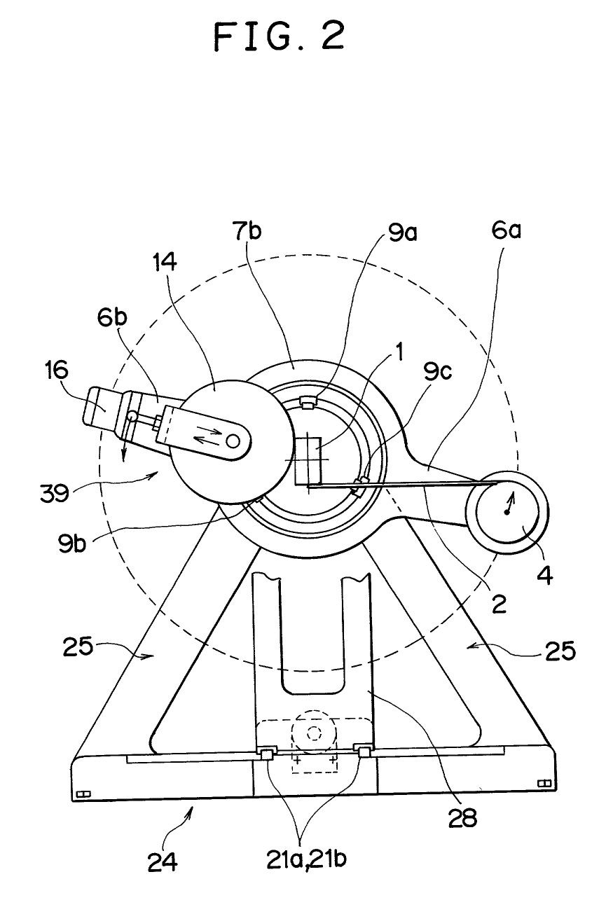

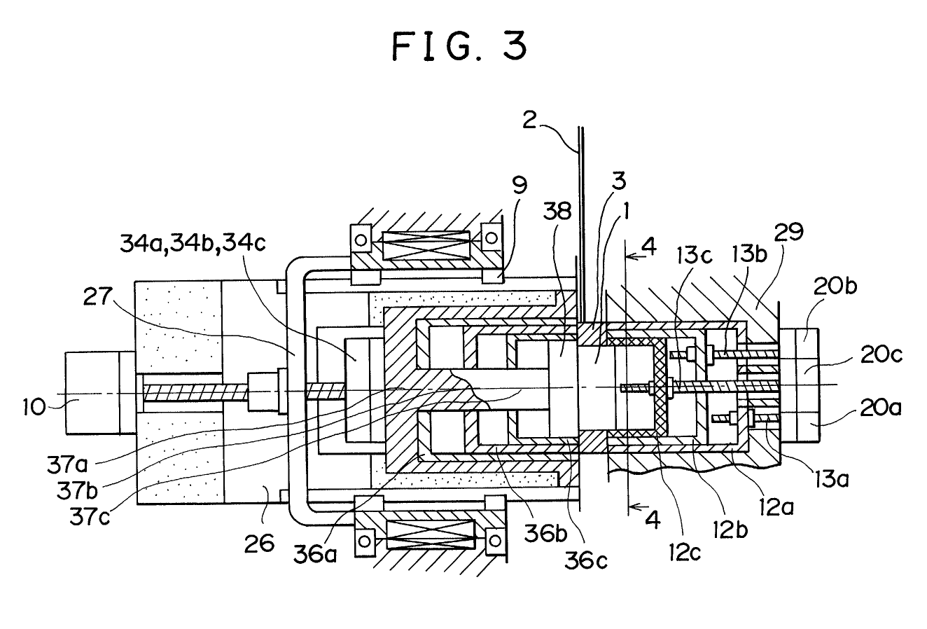

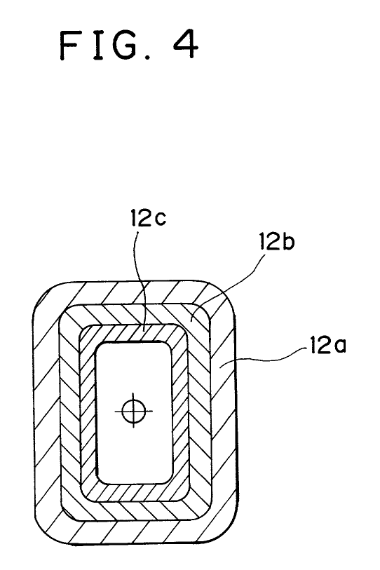

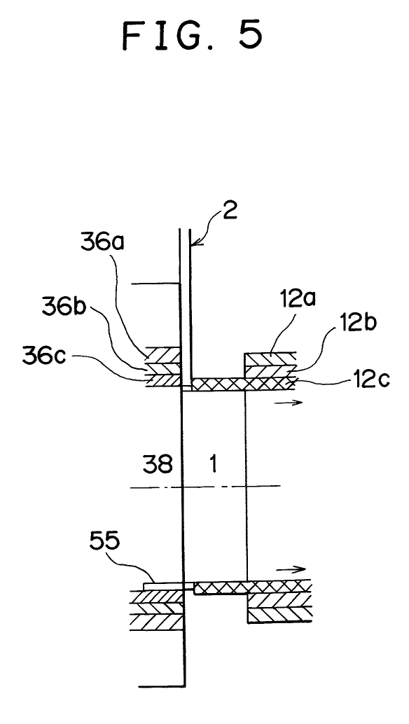

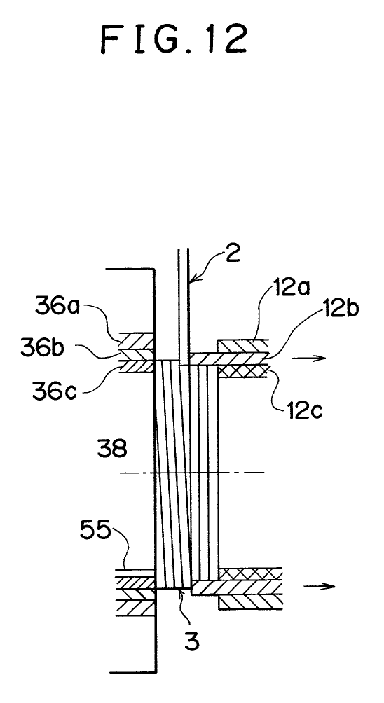

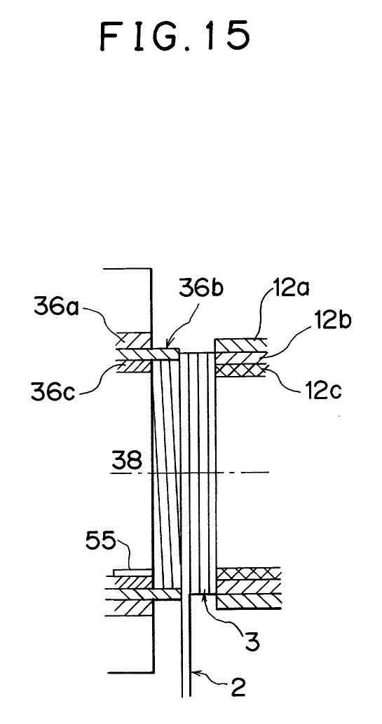

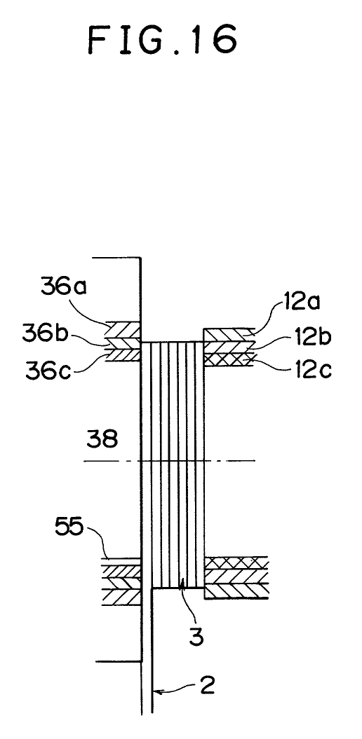

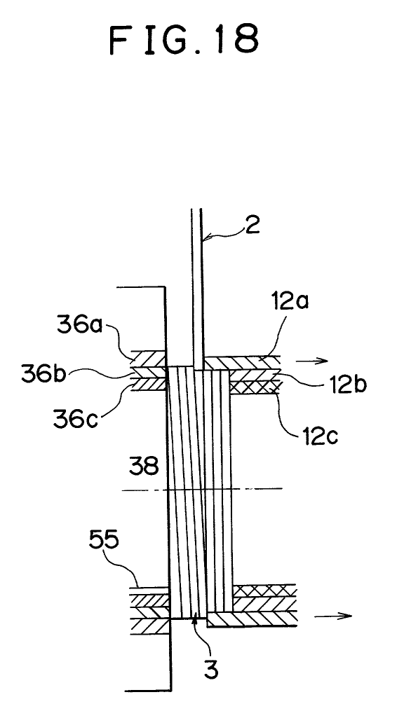

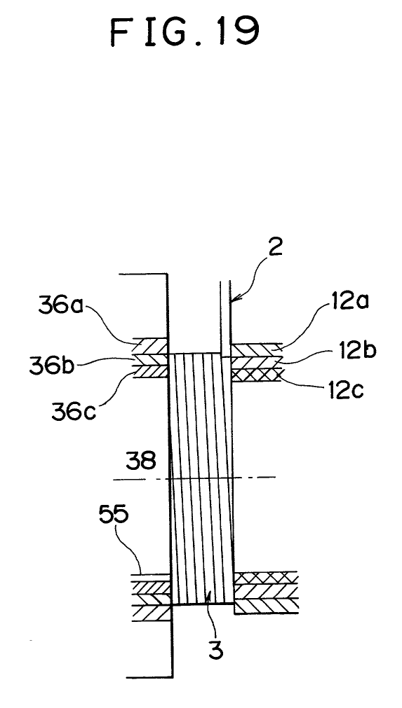

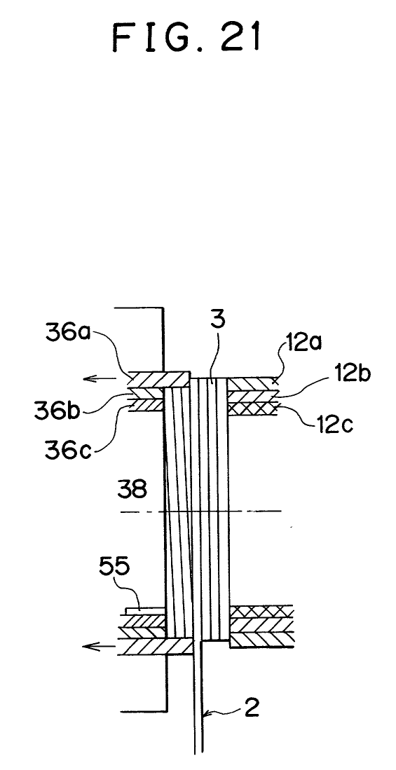

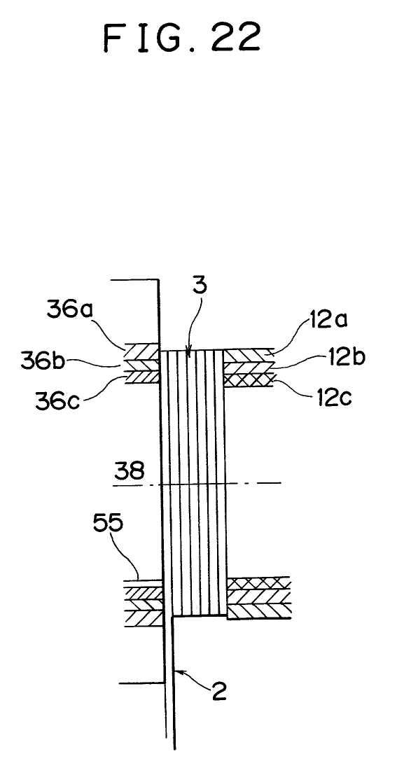

FIG. 1 is a schematic side view of a winding apparatus according to a first embodiment of the invention. FIG. 2 is a schematic elevational view of the winding apparatus. FIG. 3 is an enlarged view of a winding alignment mechanism shown in FIG. 1. FIG. 4 is a sectional view taken on line 4-4 in FIG. 3. FIGS. 5 through 22 illustrate an operation of winding a wire.

The construction of the winding apparatus of the first embodiment will first be described with reference to FIGS. 1 and 2. In this embodiment, a rectangular wire is used as an element wire 2. Referring to FIG. 1, the winding apparatus has a base 24. The base 24 has a first leg 25 that stands upward. A first head section 26 is formed above the first leg 25. The first head section 26 has a hollow where a first ball screw 11 and a winding alignment mechanism (that are described below) are mounted. The first head section 26 is provided with three first linear guides 9a, 9b, 9c. The first linear guides 9a, 9b, 9c are provided with a tubular stator 7a movable in the right-to-left directions in FIG. 1. A rotor 7b is disposed around an outer periphery of the stator 7a, and is rotatably supported by a first bearing 8. The stator 7a and the rotor 7b form a first motor 7. Disposed in a space partly defined by an inner peripheral surface of the stator 7a are a fixture member 38 for securing a winding frame 1, and a first portion 30 of the winding alignment mechanism described below. In the first head section 26, the first ball screw 11 extends at a central position of the first linear guides 9a, 9b, 9c (hereinafter, referred to as “first internal axis”). A mounting plate 27 to which the first motor 7 is secured is disposed at an intermediate portion of the first ball screw 11, orthogonally intersecting the first ball screw 11. The mounting plate 27 extends in the top-to-bottom directions in FIG. 1. Upper and lower end portions of the mounting plate 27 protrude from upper and lower grooves formed in the first head section 26, and bend rightwards in FIG. 1 to connect to the stator 7a. One end of the first ball screw 11 (left-side end in FIG. 1) is connected to a second motor 10, whereby the first ball screw 11 is rotated so as to move the mounting plate 27 and therefore the first motor 7 along the first linear guides 9a, 9b, 9c in the right-to-left directions in FIG. 1. Thereby, a position at which the element wire 2 is supplied from a wire supplying reel 4, and a winding position of the winding frame 1 are defined in a parallel alignment with respect to a direction of the diameter of the first motor 7.

The base 24 has a second leg 28 in addition to the first leg 25. Provided between the second leg 28 and the base 24 are second linear guides 21a, 21b for making it possible to change the interval between the second leg 28 and the first leg 25 so that the winding frame 1 can be removed from the fixture member 38 in the first head section 26. The second leg 28 supports a second head section 29 having a hollow in which a second portion 31 of the winding alignment mechanism, that is, a counterpart of the aforementioned first portion 30, is disposed. The second portion 31 will be described later, together with the first portion 30. The second portion 31 has a cylindrical outer peripheral surface. A second bearing 18 is provided extending around the cylindrical outer peripheral surface of the second portion 31.

The rotor 7b has a first arm 6a and a second arm 6b. The wire supplying reel 4 is mounted to the first arm 6a. A winding shaping mechanism 39 is mounted to the second arm 6b. The wire supplying reel 4 has a winding frame 5 that is rotatably mounted so that the axis of rotation thereof is parallel to the center axis of the first motor 7. The winding frame 5 carries the element wire 2 wound thereon beforehand in good alignment. Therefore, the wire supplying position of the wire supplying reel 4 regularly shifts during operation. The wire supplying reel 4 is connected to the first arm 6a so as to be rotatable at a predetermined set torque, in such a manner that the directions of revolution and rotation of the wire supplying reel 4 for supplying the element wire 2 conform to each other, as indicated in FIG. 2. The winding shaping mechanism 39 is supported by the second arm 6b and also by a third arm 32 that is supported on the second bearing 18 so as to revolve around the second head section 29. The winding shaping mechanism 39 is designed to move together with the third arm 32 as one unit. The winding shaping mechanism 39 is formed of a roller 14 for pressing the wound wire 3 around a generally rectangular prism-shaped winding frame 1, from an outer periphery, and a third linear guide 15 providing a path for movements of the roller 14 in directions of the radius of the first motor 7, and a first actuator 16 for causing movements of the roller 14 along the third linear guide 15. The winding shaping mechanism 39 is connected to the second arm 6b substantially only by a synchronous bar 19 so that the distance between the winding shaping mechanism 39 and the second arm 6b is allowed to vary when the second leg 28 is moved.

The winding alignment mechanism for 6-layer winding will be described with reference to FIGS. 3 and 4. A construction of the winding alignment mechanism located on the first head section-side will first be described. The first ball screw 11 for moving the mounting plate 27 has a free end at a side remote from the second motor 10. The fixture member 38 has three third motors 34a, 34b, 34c disposed therein. The third motors 34a, 34b, 34c rotate three third ball screws (not shown), respectively. The third ball screws are engaged with first box members 36a, 36b, 36c, respectively. The wall thickness of each box member in a direction of the radius of the first motor 7 is substantially equal to twice the thickness of the element wire 2. The first box members 36a, 36b, 36c are designed to be moved in the right-to-left directions in FIG. 3 by rotating the third ball screws. The first box members 36a, 36b, 36c differ in size from one another. Each of the large, medium and small-size first box members 36a, 36b, 36c has a generally rectangular prism shape in accordance with the shape of the winding frame 1. As shown in FIGS. l and 3, the first box members 36a, 36b, 36c are arranged in such a manner that the small-size box member (hereinafter, referred to as “first small box”) 36c is disposed inside the medium-size box member (hereinafter, referred to as “first medium box”) 36b, and the first medium box 36b is disposed inside the large-size box member (hereinafter, referred to as “first large box”) 36a. The three first boxes 36a, 36b, 36c are formed and disposed in such a manner that they fit to one another in directions of the diameter of the first motor 7 but that there are spaces left therebetween for movements relative to each other in the directions of the axis of the first motor 7. The bottom portion of the first medium box 36b has one free through-hole through which the ball screw engaged with the small box 36c extends into the medium box 36b. The bottom portion of the first large box 36a has two free through-holes through which the ball screw engaged with the small box 36c and the ball screw engaged with the medium box 36b extend, respectively. Therefore, by rotating the third ball screws, the first boxes 36a, 36b, 36c can be shifted and set in position. The bottom portion of each of the first boxes 36a, 36b, 36c has, at its center, another through-hole 37a, 37b, 37c other than the through-holes for the third ball screws. Through these through-holes 37a, 37b, 37c, the fixture member 38, carrying thereon a winding apparatus, extends connecting the winding frame 1 to the first head section 26. The means for fixing to the fixture member 38 is not particularly limited, but may employ screws, or a clamping mechanism.

A construction of the winding alignment mechanism located on the second head section-side will next be described, which is basically the same as the construction on the first head section-side. That is, the construction on the second head section-side includes three fourth motors 20a, 20b, 20c, three fourth ball screws 13a, 13b, 13c, and three box members 12a, 12b, 12c that differ in size (hereinafter, referred to as “second large box 12a”, “second medium box 12b” and “second small box 12c). FIG. 4 is a sectional view taken on line 4-4 in FIG. 3. As shown in FIG. 4, the second large, medium and small boxes 12a, 12b, 12c are formed and disposed so that smaller boxes closely fit into larger boxes, as in the first boxes 36a, 36b, 36c. The bottom portion of each of the large box 12a, the medium box 12b and the small box 12c has a through-hole although the three holes cannot be distinguished in FIG. 4. Unlike the construction on the first head section-side, the construction on the second head section-side does not include fixture of the winding frame 1. Therefore, the second boxes 12a, 12b, 12c have no through-hole other than the through-holes for the fourth ball screws 13a, 13b, 13c. The size relationship among the boxes is expressed as: first large box 36a >second large box 12a >first medium box 36b >second medium box 12b >first small box 36c >second small box 12c. The wall thickness of each box in a direction of the radius of the first motor 7 is substantially equal to twice the thickness of the element wire 2, as mentioned above. A radial dimension of the generally rectangular prism-shaped boxes, more specifically, the distance of an inner side surface of each box measured from the center axis, increments by an amount equal to the thickness of the element wire 2. For example, the above-defined radial dimension of the first small box 36c is greater than that of the second small box 12c by the thickness of the element wire 2, and the above-defined radial dimension of the second medium box 12b is greater than that of the first small box 36c by the thickness of the element wire 2.

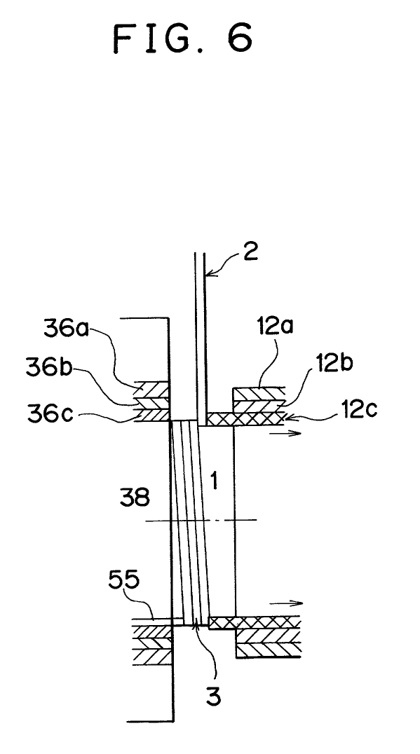

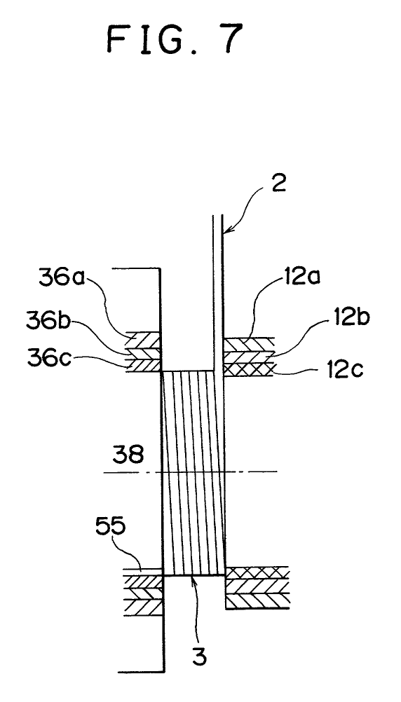

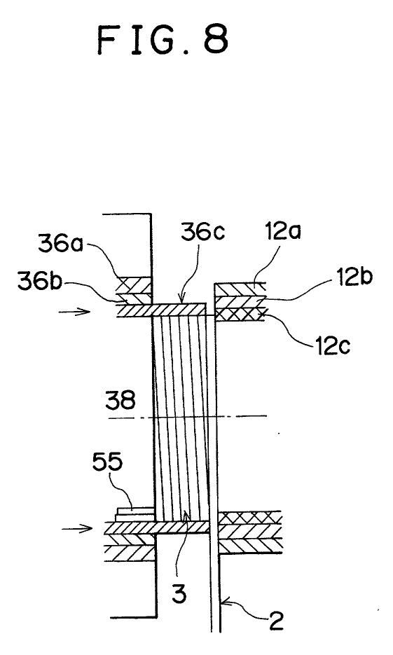

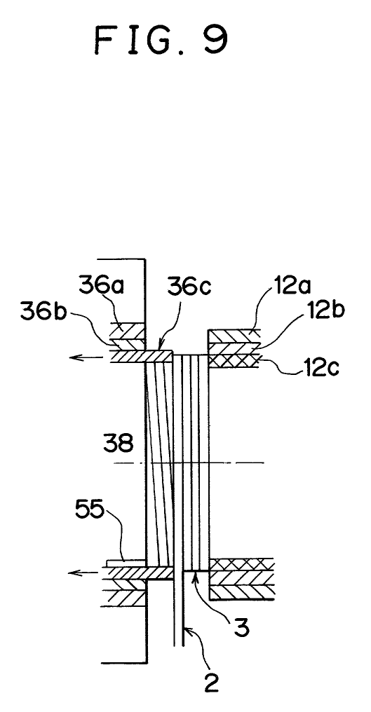

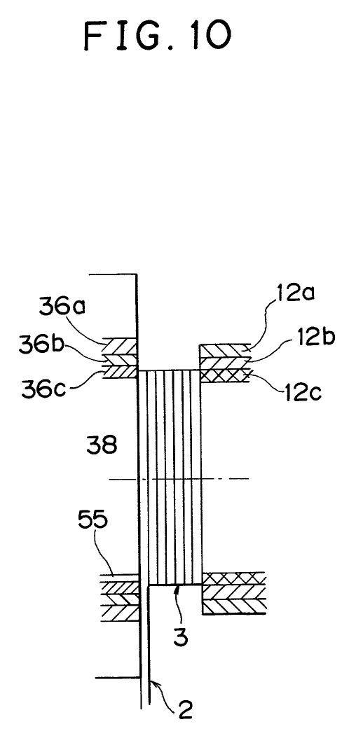

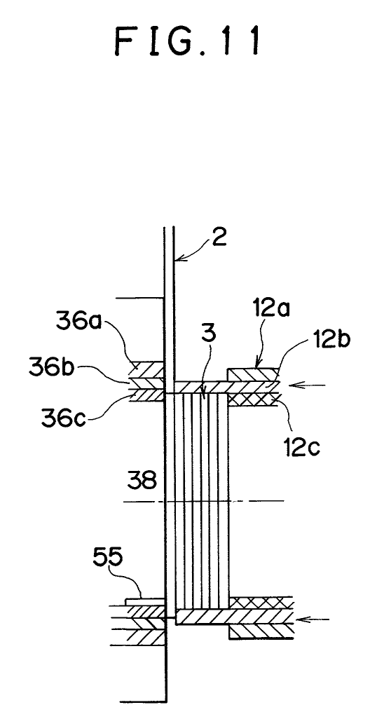

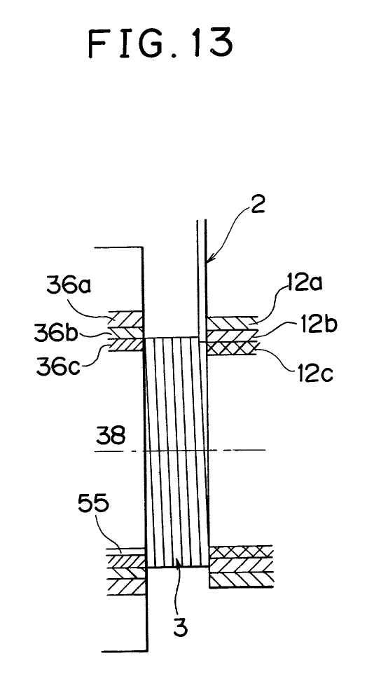

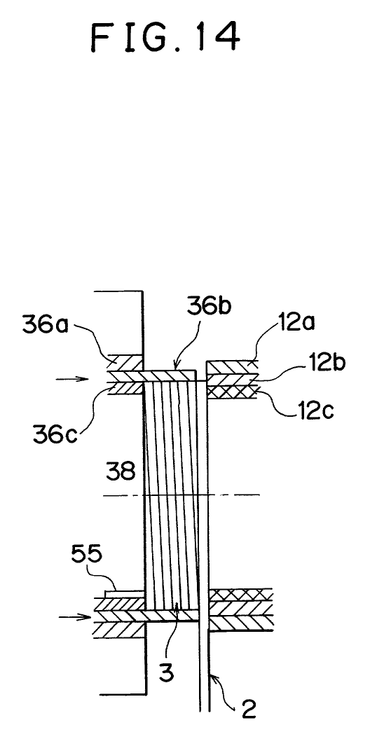

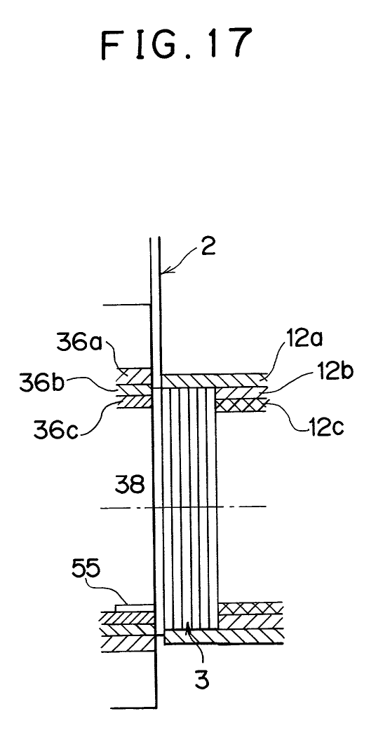

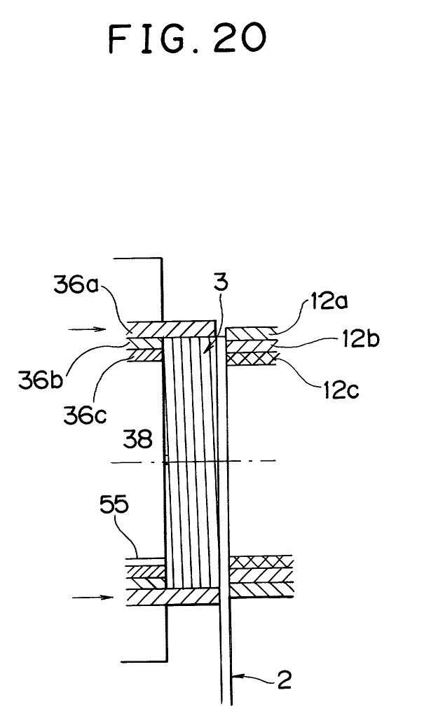

The winding method employed by the winding apparatus of this embodiment constructed as described above will be described with reference to FIGS. 1 and 2 and FIGS. 5 through 22. As shown in FIG. 1, the winding frame 1 is mounted to the fixture member 38 with the second leg 28 being set at a right-side end in FIG. 1 in its movable range. A leading end portion of the element wire 2 is secured to the fixture member 38. After that, the second leg 28 is moved leftwards until the interval between the group of the boxes (the first large box 36a, the first medium box 36b and the first small box 36c) in the first head section 26 and the group of the boxes (the second large box 12a, the second medium box 12b and the second low box 12c) in the second head section 29 becomes substantially equal to a predetermined winding range. After the second leg 28 is moved to such a suitable position, the winding operation is started. The second small box 12c is moved to the position corresponding to the first turn in the first layer of winding through rotation of the fourth ball screw 13c driven by the fourth motor 20c (the other boxes can be moved by substantially the same operations, which will not be described). Then, the first arm 6a is revolved to revolve the wire supplying reel 4 around the winding frame 1 as indicated in FIG. 2, so that the wire supplying reel 4 is also rotated in the same direction as the revolving direction to pay out the element wire 2, thereby winding it around the winding frame 1. In order to shift the turn of the element wire 2 at a position on the winding frame 1 as indicated in FIG. 5 when a round of the first arm 6a is substantially completed, the first ball screw 11 is rotated by the second motor 10 to gradually move the first motor 7 and therefore the first arm 6a to the right in FIG. 5. Simultaneously, the second small box 12c is moved leftwards to define a predetermined winding position on the side of progress of winding. That is, since a turn of winding 3 is formed on the winding frame 1 by a round of winding the element wire 2, the winding position for the second and later turns is defined by the second small box 12c and the winding 3 formed on the winding frame 1 by the previous round of the element wire 2. More specifically, to wind the element wire 2 perpendicularly to the axis of the winding frame 1, the second small box 12c is held in position to define a predetermined winding position in cooperation with the previously formed winding 3. To wind the element wire 2 obliquely to the axis of the winding frame 1, the second small box 12c is gradually moved rightwards to continuously define a predetermined oblique winding position together with the previously-formed oblique winding 3, as indicated in FIG. 6. This operation is repeated until the second small box 12c reaches the right-side end as indicated in FIG. 7. The winding shaping mechanism 39 mounted to the second arm 6b is contacted with the winding 3 from its outer periphery through control of an accumulator 17 during the winding operation (a range over which the winding shaping mechanism 39 is contacted with the winding 3 can be arbitrarily set in accordance with the required performance of the winding). The contact of the winding shaping mechanism 39 with the winding 3 is discontinued by control of the accumulator 17. When the winding operation for the second layer is to be started, the first small box 36c is moved rightwards to define a winding position for the first turn of the second layer, as shown in FIG. 8. As in the operation of the second small box 12c for the first layer, the first small box 36c defines the winding position on the winding progress side. For the second and later turns, the first small box 36c defines the winding position of the element wire 2 in cooperation with the previously formed winding 3, as shown in FIG. 9. When the first small box 36c is moved, while defining the winding position, to the left-side end as shown in FIG. 10, the winding operation for the second layer ends. The winding operation for the third and later layers is performed in manners similar to those for the first and second layers. That is, predetermined winding positions are defined on the winding progress side by using the second medium box 12b for the third layer as indicated in FIGS. 11 through 13, the first medium box 36b for the fourth layer as indicated in FIGS. 14 through 16, the second large box 12a for the fifth layer as indicated in FIGS. 17 through 19, and the first large box 36a for the sixth layer, that is, the outermost layer, as indicated in FIGS. 20 through 22. In this manner, each winding position is defined.

As is apparent from the above description, the first embodiment properly performs the aligned winding of the element wire 2 for each layer of winding under the same conditions, by defining predetermined winding positions of the element wire 2 between sandwiching box members or between a box member and the winding 3 on the winding frame 1 in each layer of winding. Furthermore, to wind the element wire 2 on the winding frame 1, the wire supplying reel 4 is revolved around the winding frame 1 together with revolution of the first arm 6a, and thereby rotated in the same direction as the revolving direction to pay out the element wire 2. Therefore, the element wire 2 is wound on the winding frame 1 against the coiling tendency or spring-back of the element wire 2 provided by the wire supplying reel 4. As a result, the element wire 2 can be wound on the winding frame 1 without forming a gap between turns of the element wire 2 or between a turn thereof and the winding frame 1. Still further, at the end of the winding operation for each layer, the winding shaping mechanism 39 presses the winding 3 from its outer periphery so as to shape the winding 3 in radial directions. Further, the winding shaping mechanism 39 is disposed at a position radially opposite from the position of the wire supplying reel 4 as shown in FIG. 2, so that the winding shaping operation and the winding operation are not simultaneously performed on the same position on the winding frame 1. Further, since the wire winding mechanism is arranged vertically, the take-up space is reduced.

Although in the first embodiment, winding is performed by the element wire supplying portion rotating around the winding portion while supplying thereto the element wire, the winding apparatus may also be designed so that the element wire supplying portion is fixed in position and the winding portion is rotated with the winding position defining device being rotated simultaneously with the winding portion (for example, the winding position defining device being combined with the winding frame fixture portion so as to rotate together as one unit). In this design, the position of the winding progress side of the element wire may be defined by the winding position defining device, with the other side position being defined by the winding formed on the winding frame.

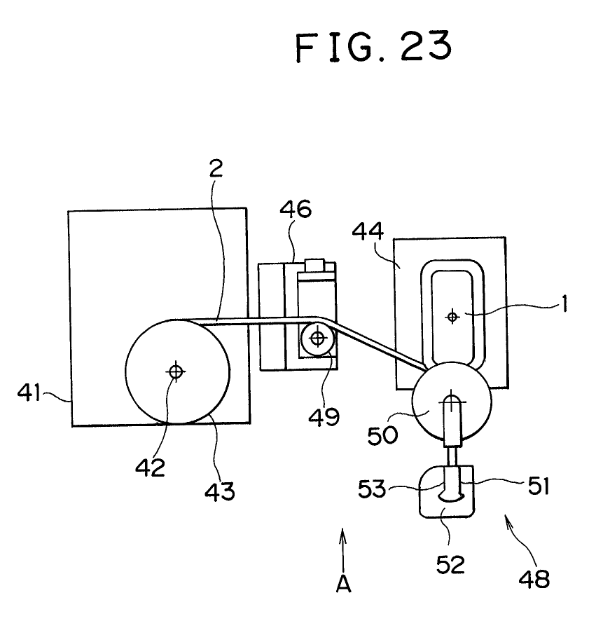

A second embodiment of the invention will now be described with reference to FIGS. 23 through 29.

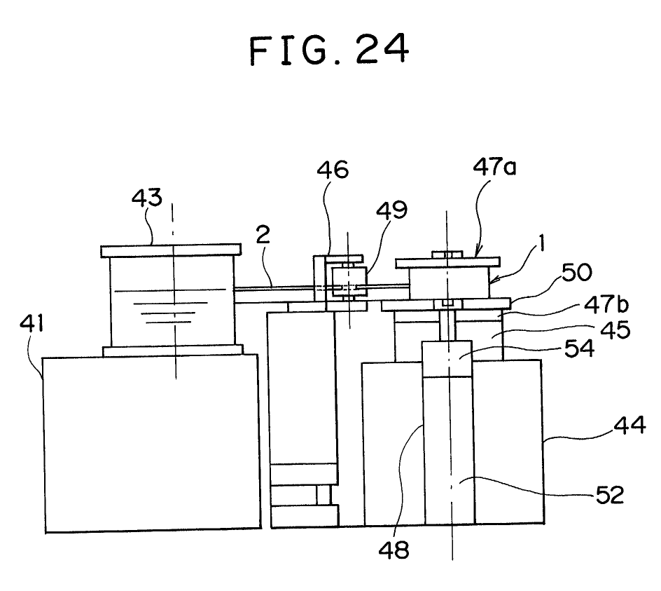

Referring first to FIGS. 23 and 24, a drum 43 is mounted on a drum mounting section 41 via a shaft 42 so that the drum 43 is rotatable by a set torque. The drum 43 carries a rectangular element wire 2 wound thereon. A winding frame driving section 44 is disposed at a side of the drum mounting section 41. The winding frame driving section 44 contains a winding motor (not shown). A table 45 connected to the winding motor is disposed on a side surface of the winding frame driving section 44. As shown in FIGS. 23 and 24, a winding frame 1, having a rectangular sectional shape on a plane perpendicular to the axis thereof, is connected to the table 45, with a side plate 47b of the winding frame 1 facing the table 45. The winding frame 1 also has a side plate 47a opposite to the side plate 47b. When the winding motor is operated, the table 45 rotates together with the winding frame 1 including the side plates 47a, 47b. The element wire 2 drawn from the drum 43 is secured to the winding frame 1. When the drum 43 rotates to pay out the element wire 2, the table 45 is rotated in a direction opposite to the rotational direction of the drum 43, so that the element wire 2 is wound on the winding frame 1 against the orientation curvature or spring-back thereof provided by the drum 43. As shown in FIGS. 23 and 24, a roller mounting section 46 is disposed between the drum mounting section 41 and the winding frame driving section 44. The roller mounting section 46 supports an element wire guide roller 49 that determines the position of winding operation on the winding frame 1 in accordance with the set position of the roller 49.

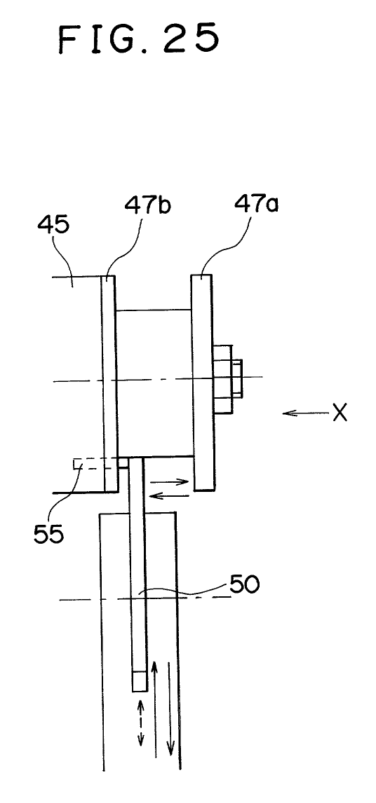

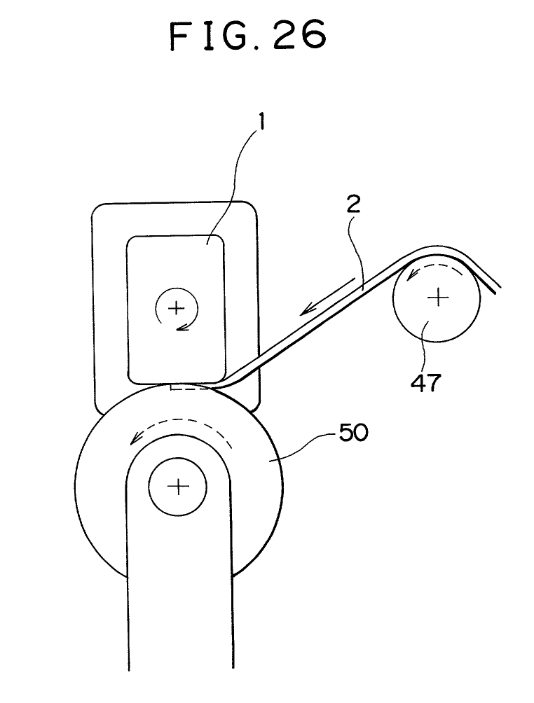

An element wire guide driving section 48 for driving a position defining roller 50 is disposed at a side of the winding frame 1, as shown in FIGS. 23 and 24. In order to contact the position defining roller 50 with the winding progression side of the winding at a predetermined winding position, the element wire guide driving section 48 includes a radial direction drive mechanism 51 for moving the position defining roller 50 in a radial direction relative to the generally rectangular winding frame 1, that is, a direction perpendicular to the axis of the winding frame 1, and an axial movement mechanism 52 for moving the position defining roller 50 in the directions of the axis of the winding frame 1. The radial direction drive mechanism 51 has a second actuator 53 for moving the position defining roller 50 into contact with the winding frame 1, whereby the distance between the position defining roller 50 and the winding frame 1 is adjusted during the winding operation. When the position defining roller 50 is in contact with the winding frame 1, the second actuator 53 is controlled so as to absorb changes in the distance between the center axis of the winding frame 1 and the winding position on its side surfaces thereof during rotation of the generally rectangular winding frame 1. The axial movement mechanism 52 has a third actuator 54 for moving the position defining roller 50 into contact with the element wire 2 or the winding 3, whereby the distance between the position defining roller 50 and the element wire 2 or the winding 3 is adjusted. The axial movement mechanism 52 moves the position defining roller 50 in the directions of the axis of the winding frame 1 following the predetermined winding positions, by moving the radial direction drive mechanism 51 connected to the position defining roller 50, in the directions of the axis of the winding frame 1. The position defining roller 50 defines predetermined winding positions on the winding frame 1 in the directions of the axis thereof. As shown in FIGS. 25 and 26, a peripheral surface of the position defining roller 50 contacts an outer peripheral surface of the winding frame 1 or the winding 3 on the winding frame 1, so that a side end surface of the position defining roller 50 guides the element wire 2. The thickness of the position defining roller 50 in the direction of the axis thereof is less than the diameter or thickness of the element wire 2.

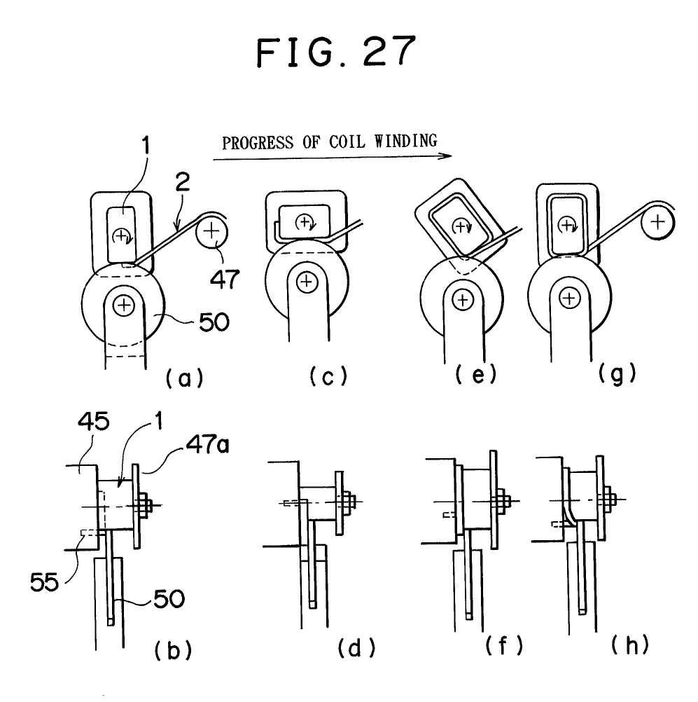

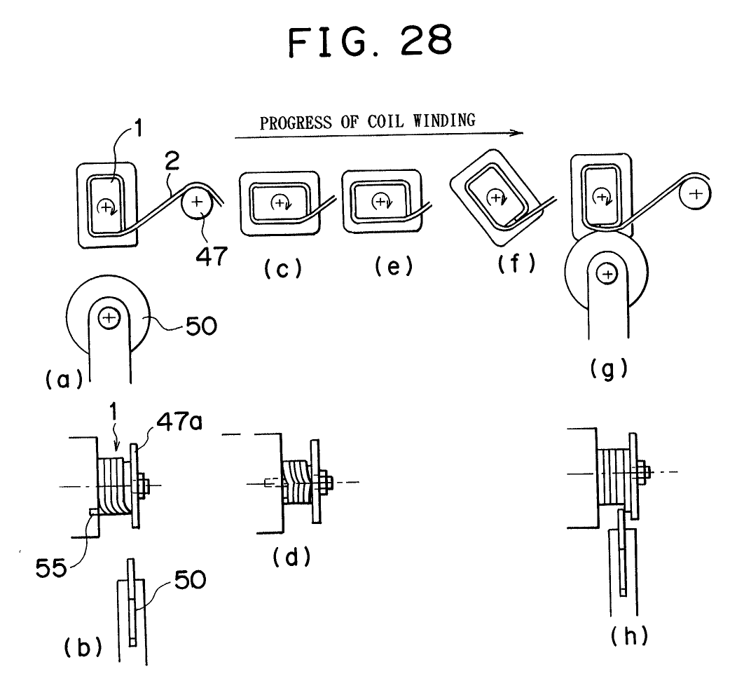

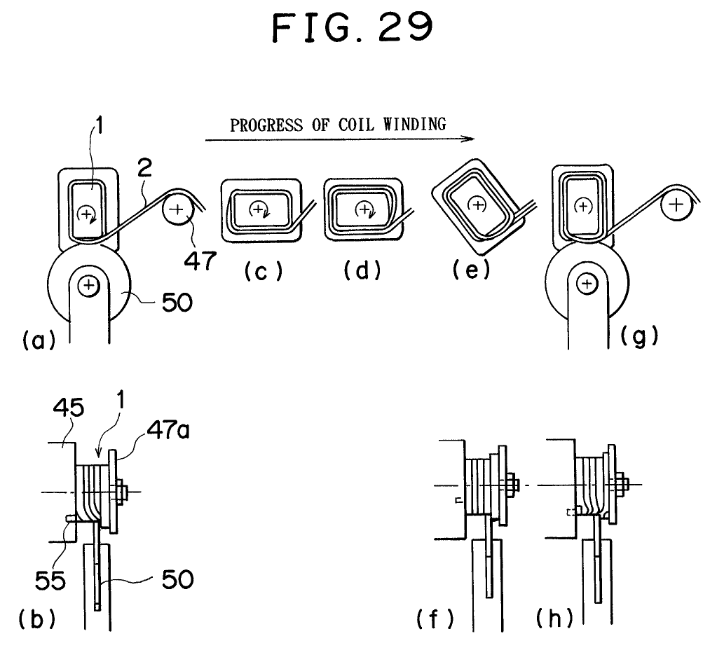

The winding method employed by the above-described winding apparatus will be described. After the winding frame 1 is secured to the table 45, an end portion 55 of the element wire 2 from the drum 43 is connected to the winding frame 1. Then, as shown in FIGS. 27(a)-27(f), the position defining roller 50 is rotated on the winding frame 1 synchronously with the progress of the winding position around the winding frame 1 while a side surface of the roller 50 remains in contact with a winding progress side of the first turn of winding on the winding frame 1 so as to guide the element wire 2 to the position of the first turn. Since the distance between the rotating axis of the winding frame 1 and the winding position on the side surfaces of the generally rectangular winding frame 1 changes as the winding frame 1 rotates, the radial direction drive mechanism 51 moves the position defining roller 50 to absorb and follow the changes in the distance so that the position defining roller 50 remains in contact with the winding frame 1. Immediately before the end of winding of the first turn, the position defining roller 50 is withdrawn in a circumferential direction and then shifted by an amount of one turn in the winding progressing direction parallel to the axis of the winding frame 1, thereby performing a turn shift of winding to the next turn (FIGS. 27(g) and 27(h)). This operation is repeated up to the last turn. For the last turn, however, the position defining roller 50 would interfere with the winding operation because the side plate 47a of the winding frame 1 prevents the turn shift of the position defining roller 50. Therefore, as shown in FIGS. 28(a) and 28(b), the position defining roller 50 is withdrawn from the winding frame 1 through control of the radial direction drive mechanism 51 to such a position that the winding operation is not impeded. The winding of the last turn of the first layer is completed in this situation (FIGS. 28(c)-28(f)). After that, the position defining roller 50 is moved into contact with the winding frame 1 at such a position as to define a predetermined winding position of the first turn of the second layer, to start winding for the second layer (FIGS. 28(g) and 28(h)). In the winding operation for the second layer (FIGS. 29(a) -29(h)), the winding progressing direction along the winding frame 1 becomes opposite from that in the winding operation for the first layer, so that the predetermined winding positions are defined by the side end surface of the position defining roller 50 opposite to the side end surface used for the winding of the first layer. The moving direction of the position defining roller 50 determined by the axial movement mechanism 52 is also reversed. Except such reversion in direction and use of different side end surfaces of the position defining roller 50, the manner of winding is substantially the same for the second and later layers. That is, for each layer, the element wire 2 is wound with the winding position being defined for every turn as described above.

In the second embodiment, the element wire 2 is tightly wound on the winding frame 1 without leaving a gap therebetween, by utilizing the spring-back of the element wire 2 provided by the drum 43. After being wound on the winding frame 1, the winding 3 is pressed from its outer periphery by the position defining roller 50, so that the winding 3 is shaped in radial directions, that is, directions perpendicular to the axis of the winding frame 1. Furthermore, since the position defining roller 50 is movable in the directions of the axis of the winding frame 1 and in the directions perpendicular to the axis thereof, the position defining roller 50 can be moved to appropriate positions for the winding of the individual layers. Therefore, the element wire 2 can be properly wound with good alignment under the same conditions for all the layers. Further, unlike the first embodiment, the second embodiment defines the predetermined winding positions by using substantially only the position defining roller 50, so that the winding apparatus can be further simplified. The layer shifts during the winding operation can easily be accomplished, merely by moving the position defining roller 50 perpendicularly to the axis of the winding frame 1.

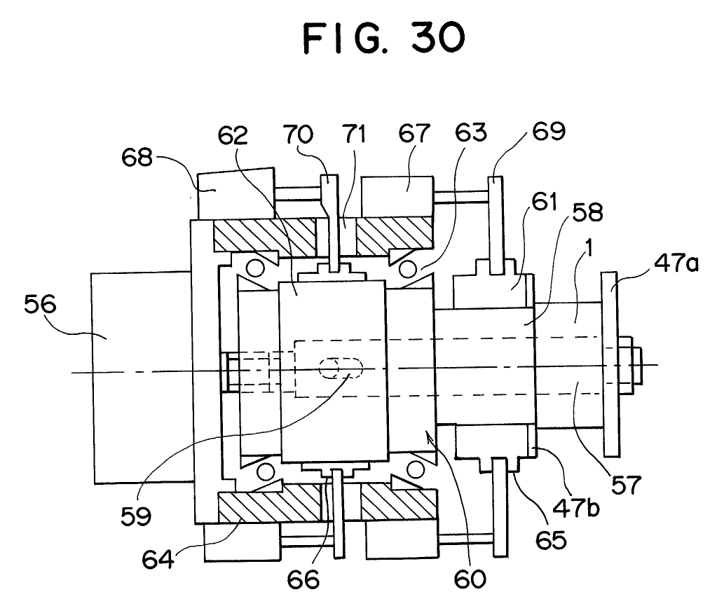

A third embodiment of the invention will be described with reference to FIGS. 30 through 35.

This embodiment employs a winding supplying section and an element wire guide driving section that are substantially the same as those in the second embodiment, and the sections will not be described. The third embodiment employs a side plate drive mechanism, which is not employed in the second embodiment and will be described below. FIG. 30 shows the side plate drive mechanism for moving a winding frame 1. An output shaft (not shown) of a winding motor 56 for rotating the winding frame 1 is connected to a center shaft 57 having a generally rectangular sectional shape on a plane perpendicular to the axis thereof. The center shaft 57 is covered with a plurality of tubular parts each having a generally rectangular inner peripheral shape substantially the same as the rectangular outer peripheral shape of the center shaft 57. More specifically, the center shaft 57 is fitted into: a side plate 47a coupled to the center shaft 57; the winding frame 1 on which the element wire 2 is wound, the winding frame 1 being movable relative to the center shaft 57 in the directions of the axis of the center shaft 57; a first cylindrical tube 58 disposed next to the winding frame 1, the first cylindrical tube 58 having a diameter that is slightly smaller than the diameter of the winding frame 1; and a second cylindrical tube 60 disposed next to the first tube 58, in that order from the end of the center shaft 57, the end being remote from the winding motor 56. The second tube 60 has a diameter slightly greater than the diameter of the winding frame 1, and has a longitudinally elongated hole 59 extending through the side peripheral wall thereof for communication with the center shaft 57. These parts and the center shaft 57 are rotated together as a unit. The first tube 58 has a side plate 47b that makes a pair with the side plate 47a to sandwich the winding frame 1. A first passive part 61 is fitted on the first tube 58 in such a manner as to be movable relative to the first tube 58 in the directions of the axis thereof. The first passive part 61 is shorter than the first tube 58. Similarly, a second passive part 62 is fitted on the second tube 60 in such a manner as to be movable relative to the second tube 60 in the directions of the axis thereof. The second passive part 62 is shorter than the second tube 60, and it is connected to the center shaft 57 through the hole 59 of the second tube 60. Formed around the outer peripheral surface of the second tube 60 is an outer tubular portion 64 that supports the second passive part 62 and the second tube 60 via a bearing 63. The second passive part 62 is provided with two actuators, that is, a fourth actuator 67 and a fifth actuator 68. The first passive part 61 and the second passive part 62 have grooves 65, 66, respectively, that extend in the outer peripheral surfaces of the parts in the circumferential directions. The grooves 65, 66 are engaged with arms 69, 70 that are moved by the fourth and fifth actuators 67, 68, respectively. The outer tubular portion 64 has longitudinally long holes 71 that are elongated in the directions of the axis thereof. Through the holes 71, the arms 70 extend to engage with the groove 66.

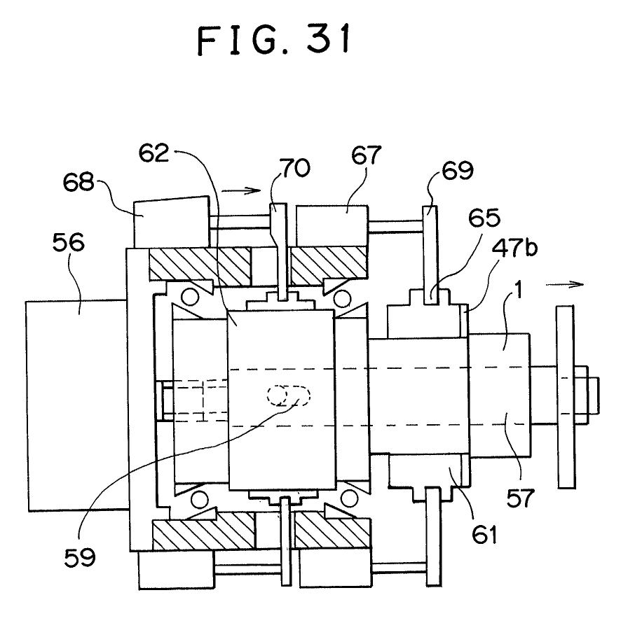

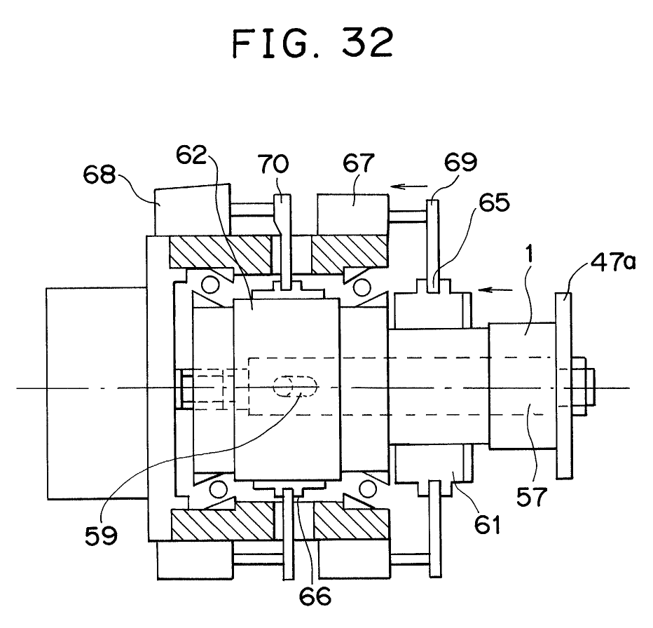

The operation of the side plate drive mechanism will be described with reference to FIGS. 31 and 32. The operation illustrated in FIG. 31 will first be described. When the fifth actuator 68 is operated to move the arms 70 in the direction indicated by an arrow (rightwards) in FIG. 31, the second passive part 62, whose groove 66 is engaged with the arms 70, is also moved. Since the second passive part 62 is connected to the center shaft 57 via the hole 59, the center shaft 57 is also moved in the direction of the arrow (rightwards) in FIG. 31. However, since the winding frame 1 is not mechanically connected to the fifth actuator 68, the winding frame 1 does not move in the direction of the axis in this operation, so that the side plate 47a, connected to the end of the center shaft 57, separates from the winding frame 1. The amount of displacement caused by the fifth actuator 68 is determined in accordance with the thickness of a position defining roller (not shown) as described below. Next, the operation illustrated in FIG. 32 will be described. When the fourth actuator 67 is operated to move the arms 69 in the direction indicated by an arrow (leftwards) in FIG. 32, the first passive part 61, whose groove 65 is engaged with the arms 69, is also moved in the direction indicated by the arrow (leftwards) in FIG. 32. In this operation, the parts, including the first passive part 61, that are not mechanically connected to the fourth actuator 67, do not receive a force to move in the direction of the axis. Therefore, the winding frame 1 separates from the first passive part 61, which includes the side plate 47b. As in the fifth actuator 68, the amount of displacement caused by the fourth actuator 67 is determined in accordance with the thickness of the position defining roller (not shown).

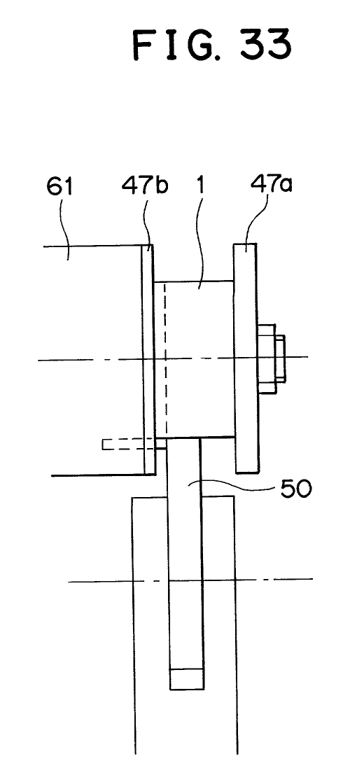

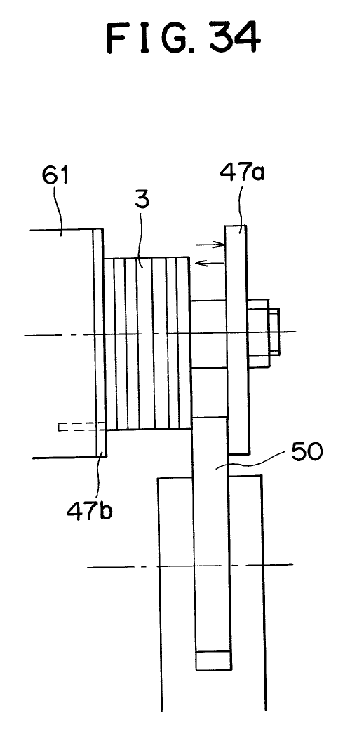

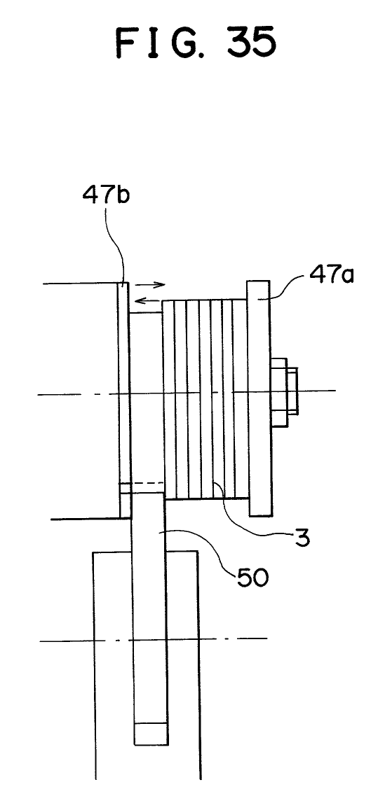

The movements of the winding frame 1, the side plates 47a, 47b, and the position defining roller 50 during the winding operation will be described with reference to FIGS. 33 through 35. The winding operation at positions on the winding frame 1, except positions on the opposite end portions thereof in the direction of the axis, is performed in substantially the same manner as in the second embodiment, as illustrated in FIG. 33. That is, winding is performed while the winding position is constantly defined by the position defining roller 50 contacting the winding progress side of the winding. However, in a winding operation at a position nearest to the side plate 47a as illustrated in FIG. 34, the side plate 47a is moved rightwards in FIG. 34 by at least an amount equal to the thickness of the position defining roller 50 by the fourth actuator 67. Subsequently, the position defining roller 50 is inserted between the side plate 47a and the corresponding end of the winding 3 in the direction of the axis in such a manner as to contact the side end surface of the winding 3. Then, the element wire 2 supplied from the wire supplying section (not shown) is guided to a predetermined winding position by the side end surface of the position defining roller 50 facing the side plate 47b (the left-side end surface of the roller 50 in FIG. 35). In a winding operation at a position nearest to the side plate 47b as illustrated in FIG. 35, the side plate 47b is moved leftwards in FIG. 35 by at least an amount equal to the thickness of the position defining roller 50 by the fifth actuator 68. Subsequently, the position defining roller 50 is inserted between the side plate 47b and the corresponding end of the winding 3 in the direction of the axis in such a manner as to contact the side end surface of the winding 3. Then, the element wire 2 supplied from the wire supplying section (not shown) is guided to a predetermined winding position by the side end surface of the position defining roller 50 facing the side plate 47a (the right-side end surface of the roller 50 in FIG. 35).

According to the third embodiment, the side plates 47a, 47b are movable in the directions of the axis thereof, so that the position defining roller 50 can be positioned on the winding progress side of the predetermined winding positions even if the thickness of the position defining roller 50 in the directions of the axis thereof is designed to be greater than the diameter or thickness of the element wire 2 for a rigidity enhancement of the position defining roller 50 relative to the element wire 2. Therefore, the element wire 2 can be properly guided to the predetermined winding position all the time.

The second and third embodiments can also be applied to a construction where the element wire supplying section is revolved around the winding portion while supplying thereto the element wire. In this case, too, if the position defining device for defining the winding position is caused to rotate synchronously with the rotation of the winding portion, the winding progress-side position of the element wire can be defined by the position defining device while the other-side position of the element wire is defined by the winding formed on the winding portion. Although the foregoing embodiments employ a roller as a position defining device, the position defining device may also be, for example, a rod-like member that has a predetermined thickness and is disposed at an outer periphery of the winding frame so that the length of the rod-like member lies in a direction perpendicular to the axis of the winding frame, or a plate-like member that has a predetermined thickness and is disposed in a similar manner, or the like.

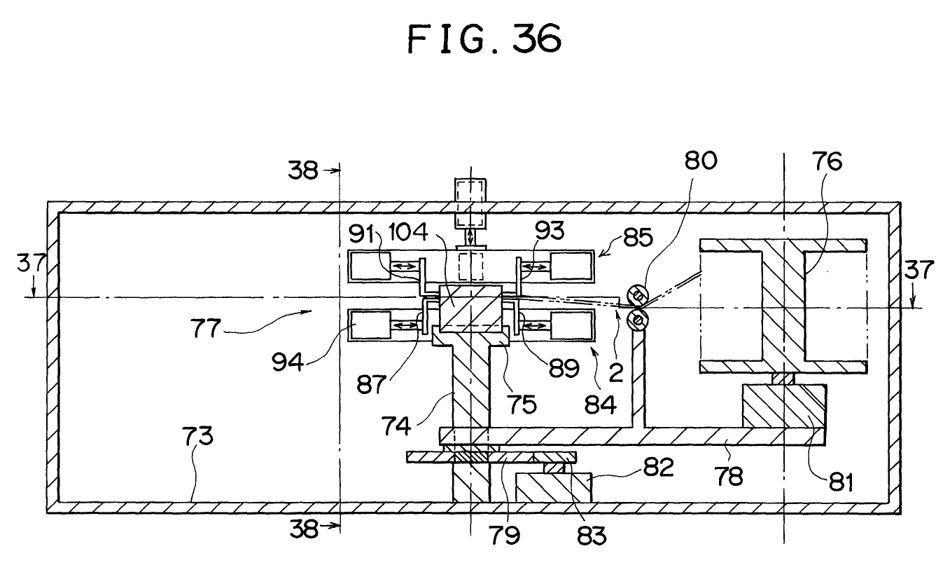

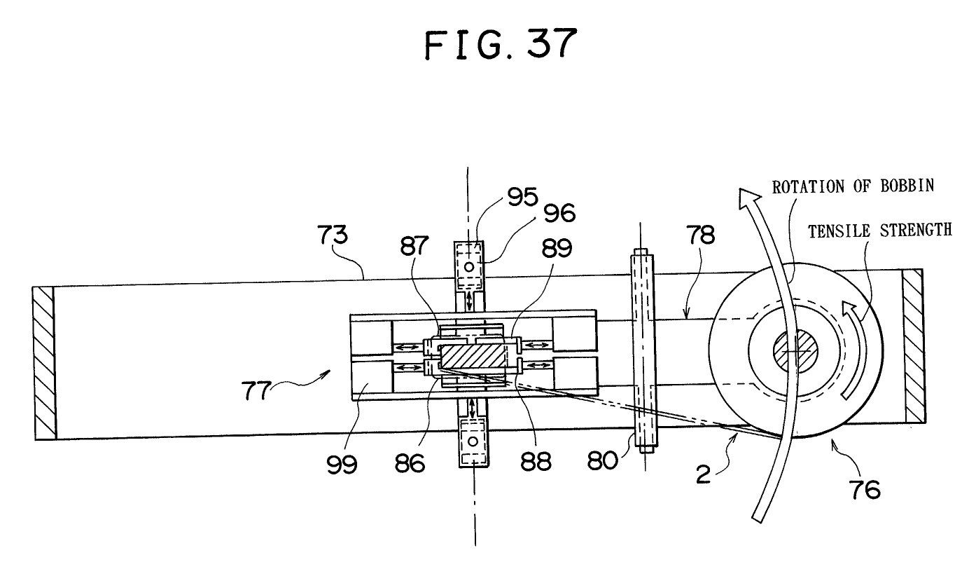

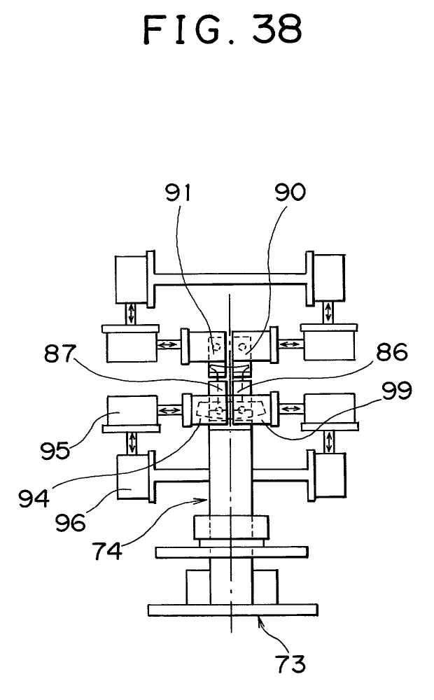

A fourth embodiment of the invention will now be described with reference to FIGS. 36 through 50. FIG. 36 shows a side sectional view of a winding apparatus according to the fourth embodiment. FIG. 37 shows a horizontal sectional view taken on line 37-37 in FIG. 36. FIG. 38 shows a vertical sectional view taken on line 38-38 in FIG. 36. In this embodiment, the winding apparatus has a case 73 that covers the winding apparatus from its top and bottom sides. A column 74 stands at a central position in a lower portion of the case 73. The column 74 has a core mounting portion 75 to which a magnetic core 72, forming a winding portion, is detachably mounted in such a manner that the winding axis of the magnetic core 72 becomes parallel to the standing direction of the column 74. The column 74 also has a portion of a guide device 77 for guiding an element wire 2 to predetermined winding positions on the magnetic core 72 mounted to the core mounting portion 75. The other portion of the guide device 77 is provided in an upper portion within the case 73.

The column 74 is provided with an arm 78 that rotates about the column 74. The arm 78 has a gear 79 at its column-side end, and further has, at the other end, an element wire supplying reel 76, that is, a supply device for supplying the element wire 2 toward the core mounting portion 75. The element wire supplying reel 76 is disposed so that its central trunk portion or its axis is parallel to the column 74. The rotation of the element wire supplying reel 76 is adjusted by adjusting the operation of a motor 81, so that the tension of the element wire 2 is adjusted. Another motor 82 is disposed on an upper surface of a lower portion of the case 73. The torque produced by the motor 82 is transmitted to the gear 79 by a gear 83, so as to rotate the arm 78 about the column 74. The arm 78 is provided with element wire guide rollers 80 for guiding the element wire 2 supplied from the element wire supplying reel 76 to the height level of the magnetic core 72. By this construction of the arm 78, the tension of the element wire 2 is controlled to a predetermined value, and the element wire 2 is guided to the height of the magnetic core 72, so that the element wire 2 can be properly wound on the magnetic core 72.

The guide device 77 includes a lower portion 84 provided on the column 74 and an upper portion 85 provided on the case 73. The lower portion 84 includes four guides 86-89 for guiding the element wire 2 from its lower side to predetermined winding positions on the winding surface of the magnetic core 72. The upper portion 85 includes four guides 90-93 for guiding the element wire 2 from its upper side to the predetermined winding positions on the winding surface of the magnetic core 72. The upper guides 90-93 and the lower guides 86-89 individually face each other so that four pairs of upper and lower guides are formed. Each of the guides 86-93 is designed to be movable three-dimensionally.

The movements of each guide 86-93 are symmetrical to the movements of the other guides in the front-rear, right-left, top-bottom and diagonal positional relationships. As a representative of the guides 86-89, the guide 87 is taken to describe the guide movements and the mechanisms therefor below. As shown in FIG. 36, the guide 87 is connected to an actuator 94 that moves the guide 87 in right-to-left directions in FIG. 36. The actuator 94 is connected to an actuator 95, as shown in FIG. 38, for movements in right-to-left directions in FIG. 38. The actuator 95 is connected to an actuator 96 for movements in top-to-bottom directions in FIG. 38. By these actuators 94, 95, 96, the guide 87 can be moved three-dimensionally. The operation of each actuator is controlled by a control device (not shown).

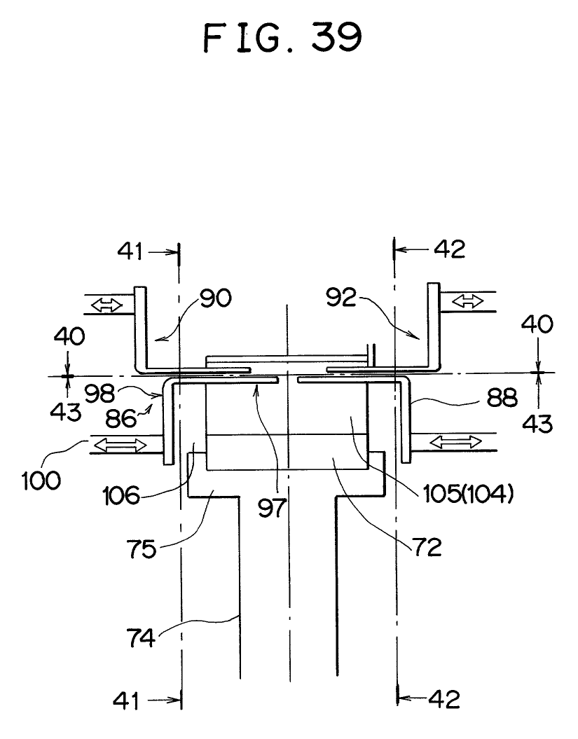

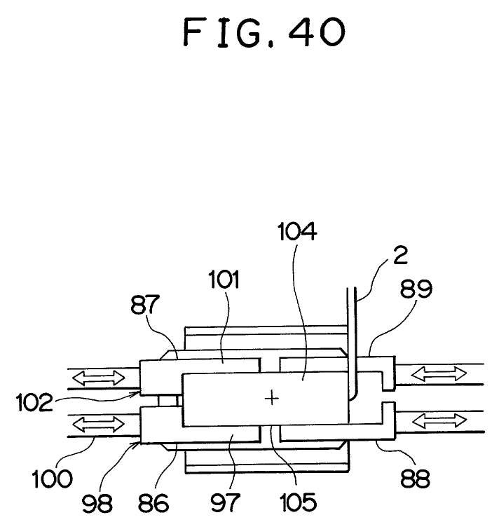

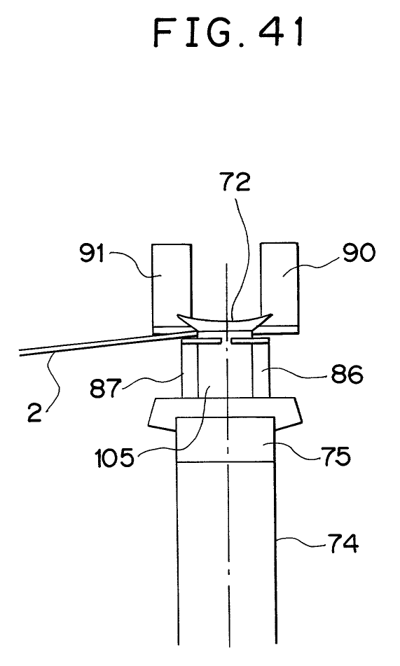

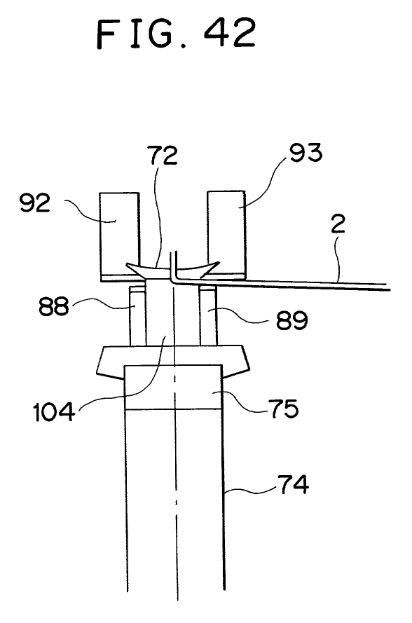

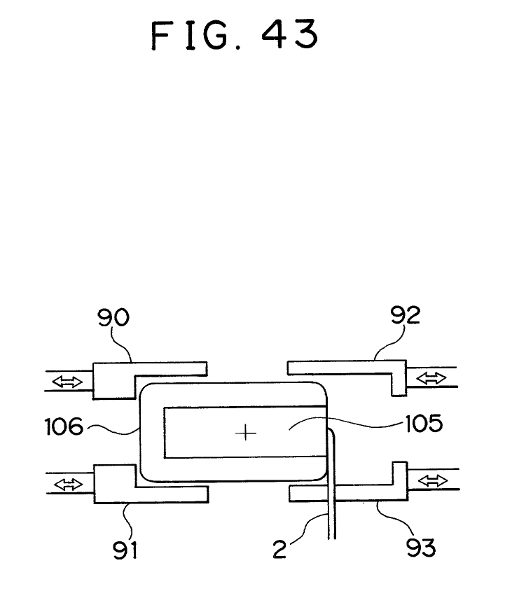

The configurations of the guides will be described. There are two types of configurations. The configurations of the four guides of each configuration type are symmetrical to one another. As representatives of the two configuration types, the guide 86 and the guide 88 are taken to describe the configurations with FIGS. 39 through 43. FIG. 39 is an enlarged view of the core mounting portion 75 shown in FIG. 36. FIG. 40 is a horizontal sectional view of the core mounting portion 75, viewed in a direction indicated by line 40-40. FIG. 41 is a view of the core mounting portion 75 in a direction indicated by line 41-41. FIG. 42 is a vertical sectional view of the core mounting portion 75, viewed in a direction indicated by line 41-42 . FIG. 43 is a vertical sectional view taken of the core mounting portion 75, viewed in a direction indicated by line 43-43.

The guide 86 has a generally “L” shape as shown in FIG. 39, with a longer side portion 97 being designed to contact the element wire 2 so as to guide it to a predetermined winding position. The longer side portion 97 of the guide 86 corresponds to a restricting member. A shorter side portion 98 of the guide 86 is provided for connection with an arm 100 extending from the actuator 99. As shown in FIG. 40, the guide 87 also has a generally “L” shape when viewed in a direction perpendicular to the winding axis of the magnetic core 72. A longer side portion 101 and a shorter side portion 102 of the guide 87 in this posture correspond to restricting members. A surface of the guide 87, including the longer and shorter side portions 101, 102, which is parallel to the sheet of the drawing and which can be seen in FIG. 40 supports the element wire 2 in such a manner that the longer side portion 101 guides the element wire 2 to a slot interior side (wider side) of a tooth 104 of the magnetic core 72 and that the shorter side portion 102 guides the element wire 2 to a coil end-side portion (narrower side) of the tooth 104 of the magnetic core 72. In the description below, the portions of the guide corresponding to restricting members will be referred to as “lug”. Each lug can contact the teeth 104, and has a thickness in the directions of the winding axis that is smaller than the diameter or thickness of the element wire 2. In a view in a direction perpendicular to a coil end-side (narrower side) surface of the tooth 104 as shown in FIG. 41 (where the coil end-side surface of the tooth 104 is clearly shown), the guide 86 includes a portion extending perpendicularly to the winding axis in such a manner as to contact and guide the element wire 2 to a predetermined winding position in a coil end-side portion.

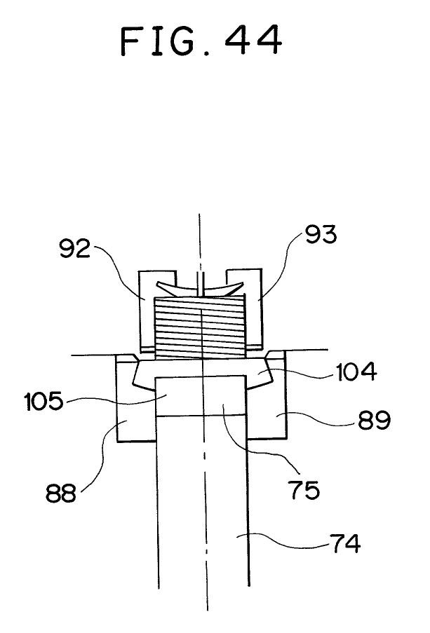

The guide 88 will next be described, mainly on differences from the guide 86. The guide 88 differs from the guide 86 in that the guide 88 does not have a portion for guiding the element wire 2 to a predetermined winding position on a coil end-side surface of the teeth 104 as can be seen from FIGS. 41 and 42. This is because in a coil end-side portion of the magnetic core 72, which portion can be seen in FIG. 44, the element wire 2 is obliquely wound for a turn shift corresponding in amount to the diameter or thickness of the element wire 2. Thus, except a portion of oblique winding, the winding trunk peripheral surface of the magnetic core 72 is surrounded by the lugs of the guides. As a structure common to all the guides, corner portions of each guide that contact the element wire 2, including outer corner portions of the L-shaped guides, and the like, are chamfered in order to prevent a scratch on the element wire 2 at the time of entrance to a space between guides and ensure smooth entrance of the element wire 2 thereinto.

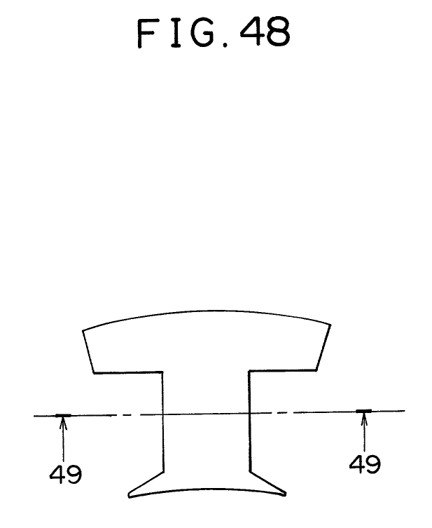

The structure of the magnetic core 72 forming a winding portion in this embodiment will be described with reference to FIGS. 48 and 49. Each magnetic core 72 has a generally “T” shape when viewed from a stator end side as shown in FIG. 48. A sectional shape of the tooth 104 of the magnetic core 72 taken on line 49-49 in FIG. 48, that is, a sectional shape thereof taken on a plane perpendicular to the winding axis, is generally rectangular as shown in FIG. 49. As indicated in FIG. 49, each core is formed by stacking magnetic steel sheets having a generally “T” shape shown in FIG. 48, in a direction perpendicular to the sheet of the drawing of FIG. 48. By winding the element wire 2 on divided cores separately, the slot spaces between teeth 104 can be highly filled with windings and, therefore, the space factor can be enhanced, in comparison with a non-divided type stator. After the element wire 2 is wound on each divided core, the divided cores are arranged into a cylindrical shape to form the stator 103.

A winding method employed by the above-described winding apparatus will now be described with reference to FIGS. 39 through 47. First, the magnetic core 72 is secured to the core mounting portion 75 after each guide has been withdrawn from the core mounting portion 75 to such a distance that the operation of mounting the magnetic core 72 is not impeded. Subsequently, the element wire 2 supplied from the element wire supplying reel 76 via the element guide rollers 80 is restrained above the magnetic core 72, which is provided with a teeth holder 105 and secured to the core mounting portion 75. The teeth holder 105 has side plates for preventing the windings from collapsing or disintegrating. However, such side plates are not provided on a stator end side where a turn shift of winding is performed. The restrained element wire 2 is lowered to the coil end-side of the magnetic core 72 provided with no side plate. At a winding position for the first turn on the teeth holder 105, the element wire 2 is bent in a circumferential direction around the winding axis. After that, the arm 78 is rotated by the motor 82 to revolve the element wire supplying reel 76 around the magnetic core 72. As the element wire supplying reel 76 revolves, the element wire supplying reel 76 pays out the element wire 2, thereby winding it on the teeth 104.

The position of each of the guides 86-93 at the time of winding the first turn will be described. As shown in FIG. 43, the guides 90-93 are withdrawn in directions perpendicular to the winding axis, to positions outwardly of the outer periphery of the side plate 106 of the teeth holder 105. In a direction of the winding axis, the guides 90-93 are moved to such positions as to directly face the side plate 106 of the teeth holder 105. The guides 86-89 are moved in directions perpendicular to the winding axis to contact tube surfaces of the teeth 104 as shown in FIG. 40. In a direction of the winding axis, the guides 86-89 are moved to such positions that the lugs of the guides 86-89 are apart from the side plate 106 by a distance substantially equal to the diameter or thickness of the element wire 2.

After the guides 86-89 are positioned around the teeth 104 as described above, the element wire 2 is wound at predetermined winding positions on the side surfaces of the teeth 104 by rotation of the arm 78 while being guided into spaces between the side plate 106 and the lugs of the guides 86-89. More specifically, when the arm 78 is rotated, the element wire 2 is guided first into a space between the side plate 106 and the lugs of the guide 89, and then into a space between the side plate 106 and the lugs of the guide 87, and then into a space between the side plate 106 and the lugs of the guide 86, and then into a space between the side plate 106 and the lugs of the guide 88, so that the element wire 2 is wound at predetermined winding positions around the teeth 104, with the teeth holder 105 sandwiched between the teeth 104 and the winding. When the element wire 2 reaches the space between the lugs of the guide 88 and the side plate 106, the winding of the first turn is completed. Since the lugs of the guides are positioned around the winding axis of the teeth 104, the element wire 2 is reliably guided to predetermined winding positions on the side surfaces of the teeth 104.

The winding of the second turn will next be described. When the element wire 2 for the first turn is guided to the space between the guide 88 and the side plate 106, the guides 89, 87 are shifted away from the side plate 106 in the direction of the winding axis, by an amount substantially equal to the diameter or thickness of the element wire 2. In addition, the guides 93, 91 are shifted away from the side plate 106 in the direction of the winding axis by an amount substantially equal to the diameter or thickness of the element wire 2. Since the thickness of the lugs of the guides 93, 91 is smaller than the diameter or the thickness of the element wire 2, the guides 93, 91 are also moved in directions perpendicular to the winding axis to contact the first turn on the teeth holder 105. As a result, the lugs of the guides 89, 87 face the lugs of the guides 93, 91, respectively, with a space substantially equal to the diameter of the element wire 2 being left therebetween, that is, astride the winding position for the second turn. Subsequently, the arm 78 is rotated, so that the element wire 2 is wound while being guided into the space between the lugs of the guide 89 and the lugs of the guide 93, and then into the space between the lugs of the guide 87 and the lugs of the guide 91. The turn shift from the first turn to the second turn can easily be accomplished since the guides 88, 89, 92, 93 do not have lugs on the coil end-side thereof as described above. After that, the guides 86, 88 are moved in substantially the same manners as in the case of the guides 87, 89. The guides 90, 92 are moved in substantially the same manners as in the case of the guides 91, 93. Subsequently, the arm 78 is rotated, so that the element wire 2 is guided into the space between the lugs of the guide 86 and the lugs of the guide 90, and then into the space between the lugs of the guide 88 and the lugs of the guide 92, thereby completing the winding of the second turn. This operation is repeated until the winding reaches the other side plate.

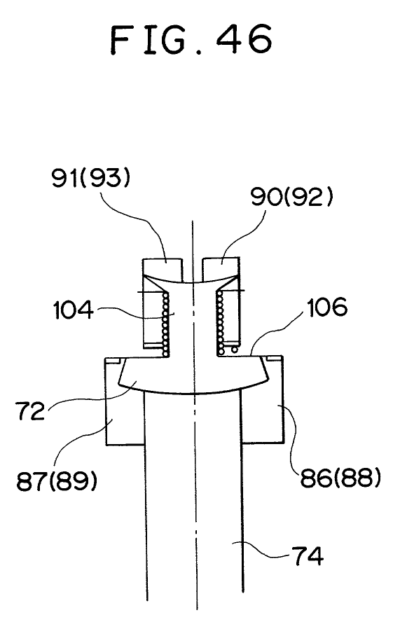

As shown in FIG. 46, for the winding of the last turn in the first layer, the guides 86-89 are withdrawn to the outer periphery of the side plate 106 of the teeth holder 105 in directions perpendicularly to the winding axis, and also withdrawn in the direction of the winding axis to such positions that the lugs of the guides directly face the side plate 106, as in the movements of the guides 90-93 for the winding of the first turn. The guides 90-93 are moved in directions perpendicular to the winding axis to contact the winding on the teeth holder 105, and moved in the direction of the winding axis to such positions that spaces substantially equal to the diameter of the element wire 2 are left between the lugs of the guides 90-93 and the side plate 106. After the guides are positioned around the magnetic core 72 in this manner, the arm 78 is rotated, so that the element wire 2 is guided first into a space between the side plate 106 and the lugs of the guide 93, and then into a space between the side plate 106 and the lugs of the guide 91, and then into a space between the side plate 106 and the lugs of the guide 90, and then into a space between the side plate 106 and the lugs of the guide 92. In this manner, the element wire 2 is wound at predetermined winding positions around the teeth holder 105 surrounding the magnetic core 72. When the element wire 2 is guided to the space between the lugs of the guide 92 and the side plate 106, the winding of the first layer is completed.

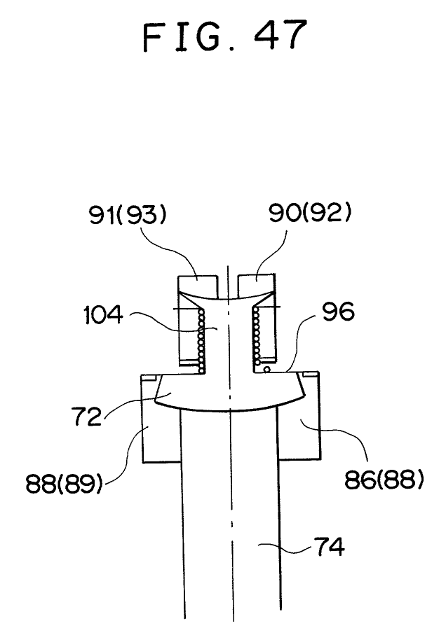

The winding of the second layer will be described with reference to FIG. 47. The guides 90-93 are moved by a distance substantially equal to the radius of the element wire 2 from the position of the end of the first layer winding toward the closer side plate 106, to prepare for the offset winding for the second layer for the purpose of increasing the winding density. The guides 86-89 are withdrawn to the outer periphery of the side plate 106 as in the end of the first layer winding. Therefore, the lugs of the guides 90-93 and the side plate 106 face one another and form spaces therebetween corresponding to the predetermined winding positions, similarly to the spaces formed for the start of the first layer winding. As the arm 78 is rotated, the element wire 2 is inserted into the spaces partly defined by the lugs of the guides 90-93 so that the element wire 2 is wound at the predetermined winding positions. Then, the winding is performed by repeating the operation substantially the same as in the first layer winding, except that the guides are moved in the direction of the winding axis opposite to the guide moving direction for the first layer winding, and that the winding positions for the second layer in the direction of the winding axis are offset by half the diameter of the element wire 2 from the winding positions for the first layer, which is beneath the second layer.

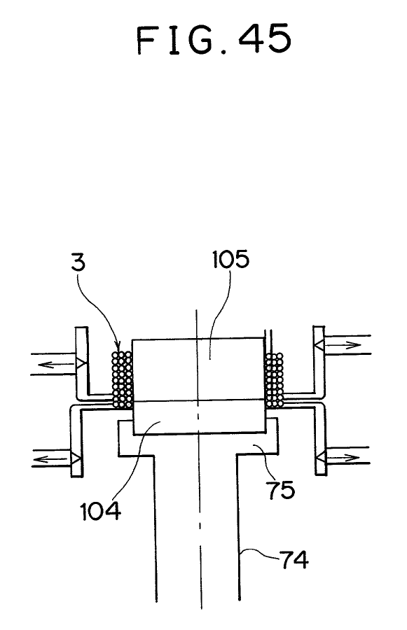

By repeating the above-described operation for every turn of each layer, a coil winding with good alignment as shown in FIG. 45 is formed.

In the fourth embodiment, the element wire supplying reel 76 corresponds to a supplying device, and the motor 82 and the arm 78 correspond to a winding apparatus, and the guides and the actuators therefor correspond to a guiding device, and the lugs of the guides and the side plates 106 correspond to restricting members. Spaces for guiding and restricting the element wire 2 are formed between the lugs or between the lugs and the side plate which are astride predetermined winding positions and apart from each other by an interval substantially equal to the diameter of the element wire 2. Therefore, the element wire 2 is precisely guided to the predetermined winding positions by passing the element wire 2 through the guiding/restricting spaces. Furthermore, even if the element wire 2 has a bend, aligned winding is ensured by passing the element wire 2 through the aforementioned spaces. As a result, the space factor of the winding is enhanced, thereby increasing the efficiency and output of the electric motor. Further, since lugs are not provided on a side of the magnetic core where the turn shifts of winding are performed, the oblique winding for every turn shift can easily be performed. Still further, since the guides can be withdrawn in directions perpendicular to the winding axis, the element wire 2 can be wound precisely at predetermined winding positions, even for the starting or ending turn of each layer by withdrawing the guides which would otherwise interfere with the side plate or the like and by positioning the other guides to form wire guiding spaces in cooperation with the side plate. Further, since the thickness of the lugs in the direction of the winding axis is smaller than the diameter of the element wire 2, the element wire 2 can be wound precisely at predetermined winding positions even for the second turn and the turn immediately before the last of each layer.

Although in the fourth embodiment an offset-aligned coil winding is produced by offsetting the winding positions partly defined by the lugs for one layer by an amount substantially equal to the radius of the element wire 2 from the winding positions for the immediately inner or outer layer, it is also possible to wind the element wire 2 without offsetting the winding positions from one layer to another.

In the fourth embodiment, the magnetic core, forming a winding portion, is fixed in position and the element wire supplying reel (supplying device) is revolved around the magnetic core to wind the element wire on the winding portion. However, the invention is not limited to this manner of winding. It is also possible to fix the supplying device in position and rotate the winding portion so as to wind an element wire on the winding portion. Such a modification is able to achieve substantially the same winding precision as in the fourth embodiment, by rotating a guiding device together with the winding portion as a unit. Since the supplying device does not turn, this modification can correspondingly reduce the size of the winding apparatus and the installation space required for the winding apparatus.

Furthermore, in the first to fourth embodiments, the element wire may also be a power cable, or a filament, and the winding portion may also be used as a frame for winding the power cable or the filament. That is, the winding apparatus may also be used as a device for winding a power cable or a filament. The winding apparatus of the invention is not restricted by the foregoing embodiments, but may be used to wind any linear material.

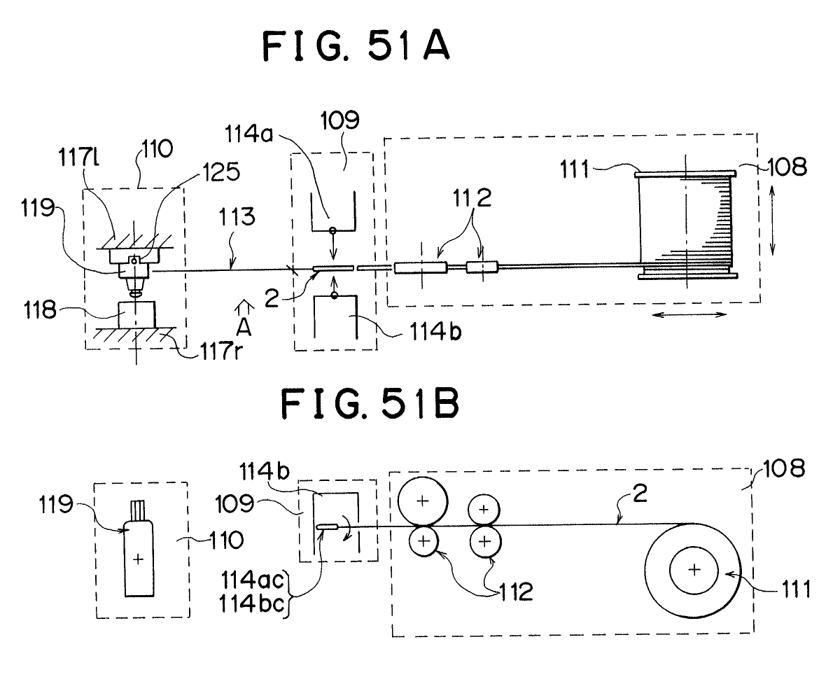

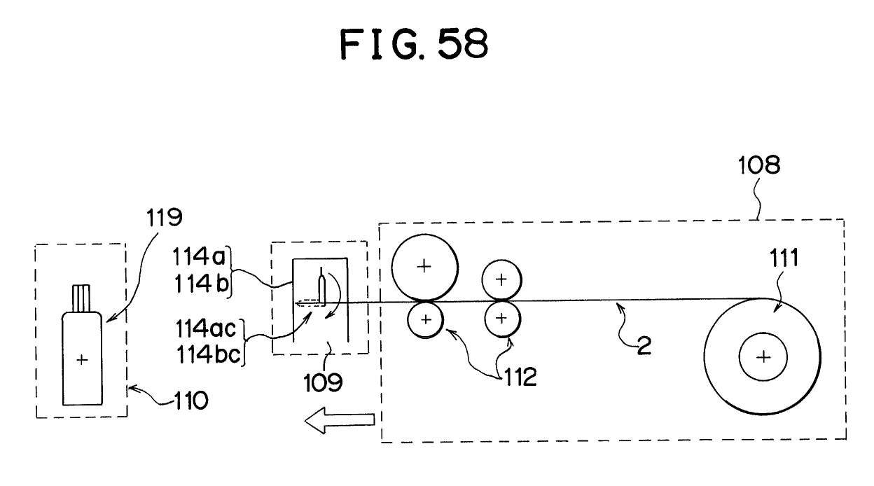

A fifth embodiment of the invention will be described with reference to FIGS. 51 through 65.

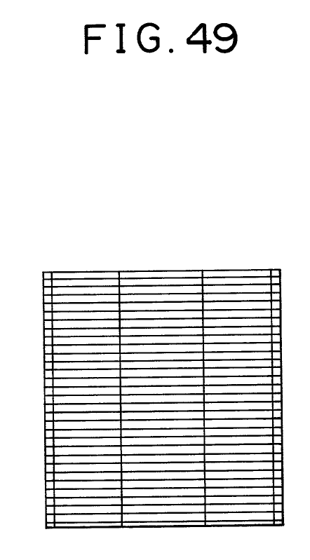

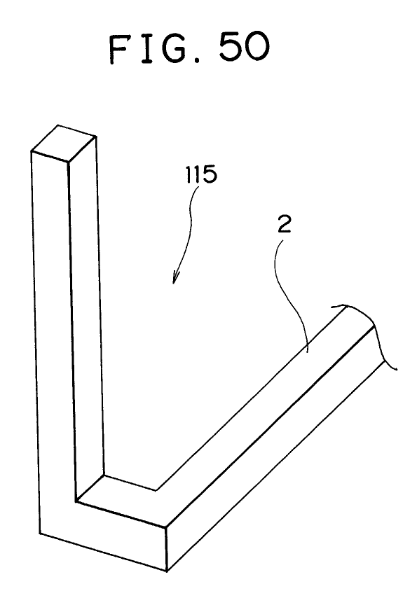

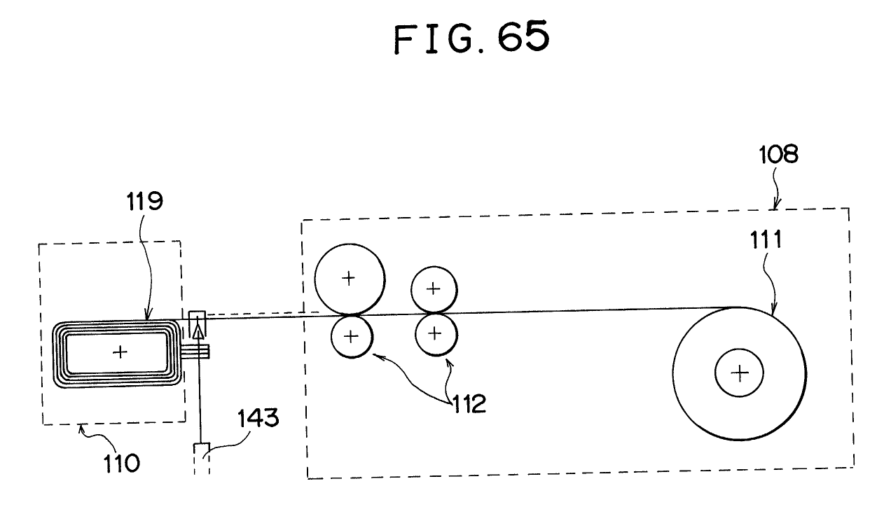

The arrangement of a winding apparatus according to the fifth embodiment will first be described with reference to FIGS. 51A and 51B. In this embodiment, a rectangular wire, that is, a wire having a generally rectangular sectional shape on a plane perpendicular to the axis of thereof, is used as an element wire 2 (a similar element wire is also used in a sixth embodiment of the invention). As shown in FIGS. 51A and 51B, the winding apparatus of the fifth embodiment includes an element wire supplying unit 108 for supplying the element wire 2, and a lead portion forming unit 109 for forming a winding-start lead portion 115 of the element wire 2 having a configuration as shown in FIG. 50 before the winding of the element wire 2 on a winding portion is started. The lead portion 115 of the element wire 2 serves as a lead terminal for electrical wiring when the winding formed by the winding apparatus is mounted in an electric device, such as an electric motor. The winding apparatus further includes a winding unit 110 for winding the element wire 2 on a winding frame 119. Although not shown in FIGS. 51A and 51B, the winding apparatus of this embodiment further includes a cutting unit for cutting the element wire 2 by using a cutter 143 (see FIG. 65) when the winding is completed.

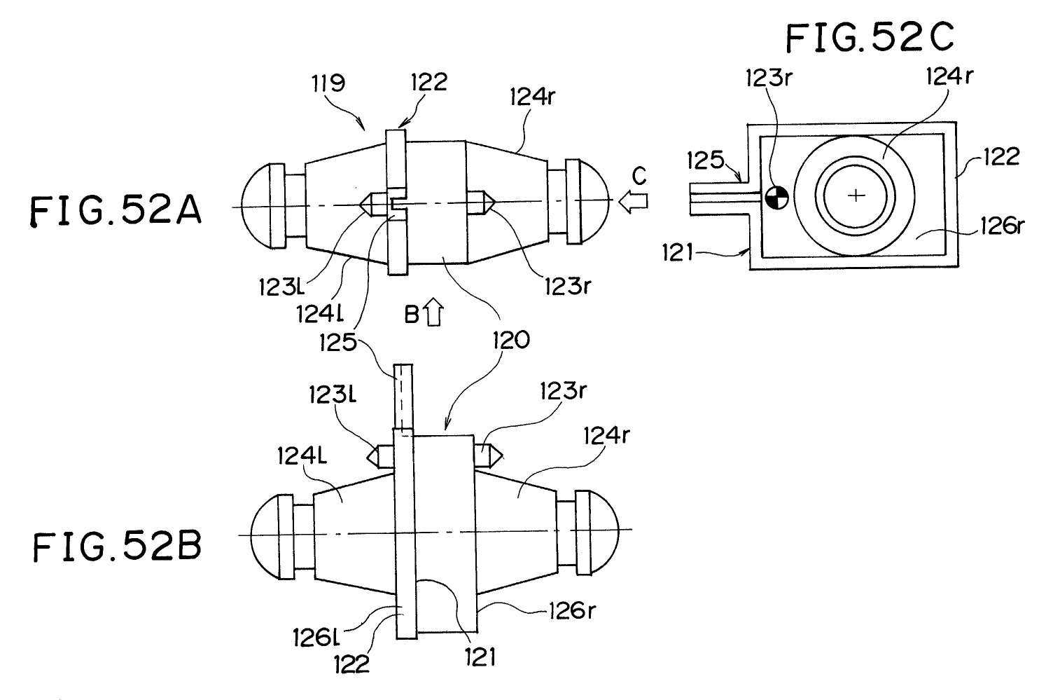

The element wire supplying unit 108 includes an element wire reel 111 carrying the element wire 2 wound thereon, and element wire guides 112 formed by two pairs of drive rollers. The element wire 2 is paid out by the element wire reel 111 and guided toward the lead portion forming unit 109 and the winding unit 110 by rotation of the element wire guide rollers 112. The element wire reel 111 is supported by a shaft (not shown) that is provided with a mechanism for applying a tension to the element wire 2 during the winding operation. The element wire supplying unit 108 is movable in left-to-right, top-to-bottom, and front-to-rear directions in FIG. 52A by drive devices (not shown). The lead portion forming unit 109 has a pair of forming dies 114a, 114b that face each other across an element wire supplying path 113, whereby a leading end portion of the element wire 2 is formed into the winding-start lead portion 115.

The winding unit 110 will be described. An overall construction thereof will first be described with reference to FIGS. 51A and 51B. The winding unit 110 includes a left-side main shaft 117l and a right-side main shaft 117r that face each other with a predetermined interval left therebetween. The winding frame 119 having a generally rectangular sectional shape is mounted to the left-side main shaft 117l. A first-layer aligning cup 118, that is, a position defining device for defining winding positions of the element wire 2, is mounted to the right-side main shaft 117r. The winding frame 119 can also be detachably fitted to the right-side main shaft 117r, as described in detail below. Briefly, the left-side main shaft 117l and the right-side main shaft 117r have identical detachable female fitting structures, and the winding frame 119 and the first-layer aligning cup 118 have identical detachable male fitting structures. The winding frame 119 and the first-layer aligning cup 118 are mounted to the main shafts 117r, 117l in such a manner that the center axes of the winding frame 119 and the first-layer aligning cup 118 and the center axes of the main shafts 117r, 117l coincide. The main shafts 117r, 117l are rotated about their center axis in synchronous phase and at equal speeds by rotating mechanisms (not shown). The winding frame 119, the first-layer aligning cup 118 and the main shafts 117r, 117l will be described in detail below.

The construction of the winding frame 119 will be described with reference to FIGS. 52A, 52B and 52C. The winding frame 119 is designed to form an aligned/packed coil 127 having a generally rectangular tubular shape as shown in FIG. 66. Therefore, the winding frame 119 has a four-sided winding portion 120 around which the element wire 2 is wound. A shoulder portion 122 is formed on an end of the winding portion 120 in a direction of the axis of the winding frame 119. The shoulder portion 122 has a winding start reference surface 121 that provides a reference position to start winding the element wire 2 on the winding portion 120. The winding portion 120 is further provided with phase defining pins 123r, 123l that are formed on the opposite end surfaces 126r, 126l of the winding portion 120 in the directions of the axis thereof. The phase defining pins 123r, 123l serve as reference positions when the winding frame 119 is mounted to the right-side main shaft 117r and the left-side main shaft 117l, respectively. Male chuck tapers 124r, 124l for detachably fitting to the main shafts 117r, 117l, respectively, are formed on the opposite ends surfaces 126r, 126l of the winding portion 120 in the directions of the axis thereof. The male chuck tapers 124r, 124l are disposed coaxially with the center axis of the winding frame 119. The male chuck tapers 124r, 124l are retained to the main shafts 117r, 117l by retaining mechanisms (not shown) formed in the main shafts 117r, 117l. The shoulder portion 122 has a retaining grooved projection 125 for retaining the winding-start lead portion 115 of the element wire 2. That is, the retaining grooved projection 125 serves as a fixture portion for the element wire 2 during the winding operation.

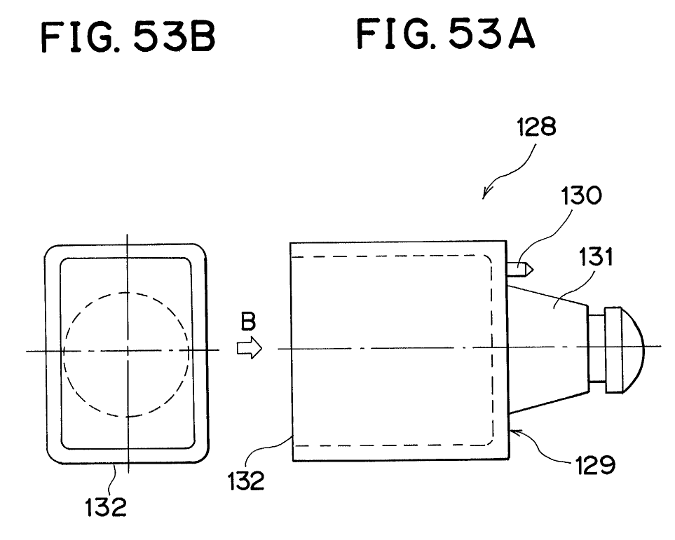

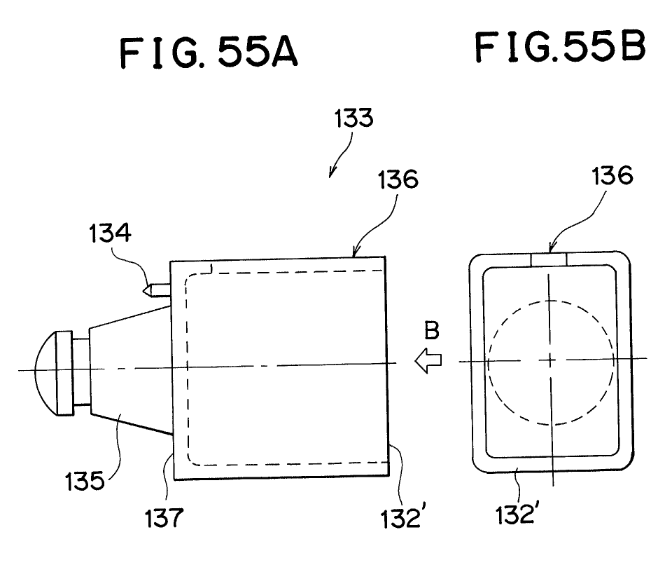

The aligning cup, that is, a position defining device, will be described with reference to FIGS. 53A, 53B, 54A, 54B, 55A, 55B, 56A and 56B. The aligning cup defines the position of the element wire 2 only on its winding progress side and thereby guides the element wire 2, as in the position defining devices in the first to third embodiments. The aligning cup is replaced by another aligning cup at every layer shift of winding. That is, different aligning cups are provided corresponding to the number of winding layers to be formed. The configurations of aligning cups are roughly divided into two types, that is, for odd number layers and for even number layers. The configuration of an odd number layer will first be described with reference to FIGS. 53A and 53B. An odd number-layer aligning cup 128 is provided in the form of a cup having a generally rectangular interior configuration corresponding to the rectangular exterior configuration of the winding frame 119 or the aligned/packed coil 127. A bottom portion 129 of the odd number-layer aligning cup 128 is provided with a phase defining pin 130 and a male chuck taper 131 that are respectively identical to those of the winding frame 119. An edge surface 132 around the opening of the odd number-layer aligning cup 128 serves as a surface that defines the winding position of the element wire 2 (hereinafter, the opening edge surface is referred to as “aligning surface”). The interior configuration of the odd number-layer aligning cup 128 is defined as follows. The interior space of the first-layer aligning cup 118 has such a depth that the first-layer aligning cup 118 can completely cover the male chuck taper 124r and the winding portion 120 of the winding frame 119. The interior configuration of the first-layer aligning cup 118 is formed so that the aligning surface 132 contacts the winding start reference surface 121 of the winding frame 119 and so that the gap between the inner peripheral surfaces of the first-layer aligning cup 118 and the winding portion 120 of the winding frame 119 is less than the thickness of the element wire 2. The thickness of the side walls of the first-layer aligning cup 118 or the width of the aligning surface 132 thereof is appropriate in accordance with the thickness of the element wire 2 so that when the winding position is to be defined, the aligning surface 132 secures the element wire 2 without allowing the element wire 2 to shift. The third-layer and later odd number-layer aligning cups 128 have an interior depth that is equal to or may be greater than that of the first-layer aligning cup 118. The inner peripheral surfaces of the third-layer aligning cup 128 are defined so that the third-layer aligning cup 128 closely fits over the first two layers of windings (of element wire 2) formed on the winding frame 119. The inner peripheral surfaces of the fifth-layer aligning cup 128 are defined so that the fifth-layer aligning cup 128 closely fits over the four layers of windings (of the element wire 2) formed on the winding frame 119. The inner peripheral dimensions of the odd number-layer aligning cup 128 are thus regularly increased. The configuration of even number-layer aligning cups 133 will now be described with reference to FIGS. 55A, 55B. The configuration of an even number-layer aligning cup 133 is substantially the same as that of an odd number-layer aligning cup 128. That is, a bottom portion 137 of each even number-layer aligning cup 133 is provided with a phase defining pin 134 and a male chuck taper 135. The length of the phase defining pin 134 and the length of the male chuck taper 135 are longer than the lengths of the respective counterparts of an odd number-layer aligning cup 128, by an amount equal to the thickness of the shoulder portion 122 of the winding frame 119. A side surface of the even number-layer aligning cup 133 near the phase defining pin 134 has a groove 136 that extends from an aligning surface 132′ around the opening, toward the bottom portion 137. The groove 136 has a depth or length corresponding to the distance between the end surfaces 126r and 1261 of the winding portion 120, and has such a width that the retaining grooved projection 125 of the winding frame 119 can pass through the groove 136. The interior dimensions of the even number-layer aligning cups 133 are regularly determined as in the odd number-layer aligning cups 128. That is, the depth thereof is substantially the same as that of the odd number-layer aligning cup 128. The inner peripheral surfaces of the second-layer aligning cup 133 are defined in size so that the second-layer aligning cup 133 closely fits over the first layer of windings (of element wire 2) formed on the winding frame 119. The inner peripheral surfaces of the fourth-layer aligning cup 133 are defined in size so that the fourth-layer aligning cup 133 closely fits over the three layers of windings (of the element wire 2) formed on the winding frame 119.

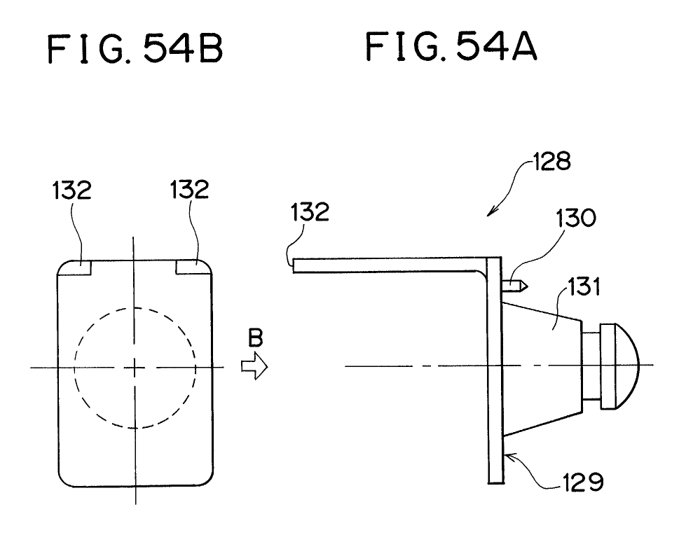

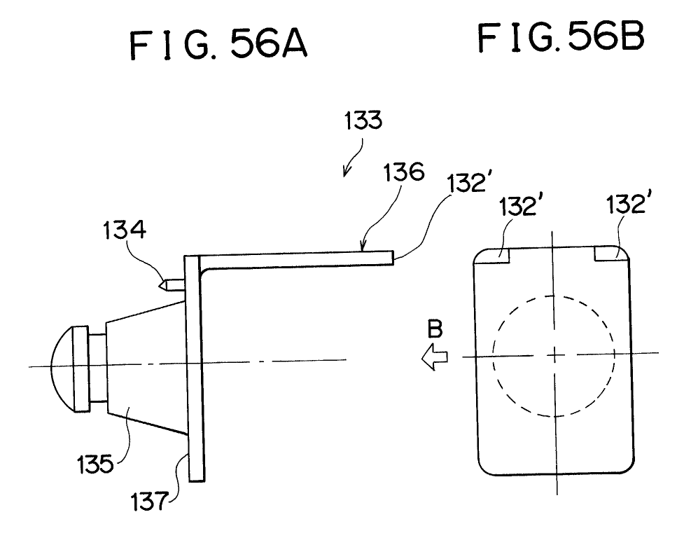

Although in the above description, the aligning surface 132 of the odd number-layer aligning cup 128 and the aligning surface 132′ of the even number-layer aligning cup 133 have such a shape as to cover the entire winding frame 119, such a configuration is merely an illustrative example for a case where the need for the aligning surfaces is maximum. The degree of the need for the aligning surfaces depends on the rigidity of the element wire 2, the winding site, and the like. If it is easy to align an element wire, the aligning surfaces may be omitted as shown in FIGS. 54A, 54B, 56A and 56B.

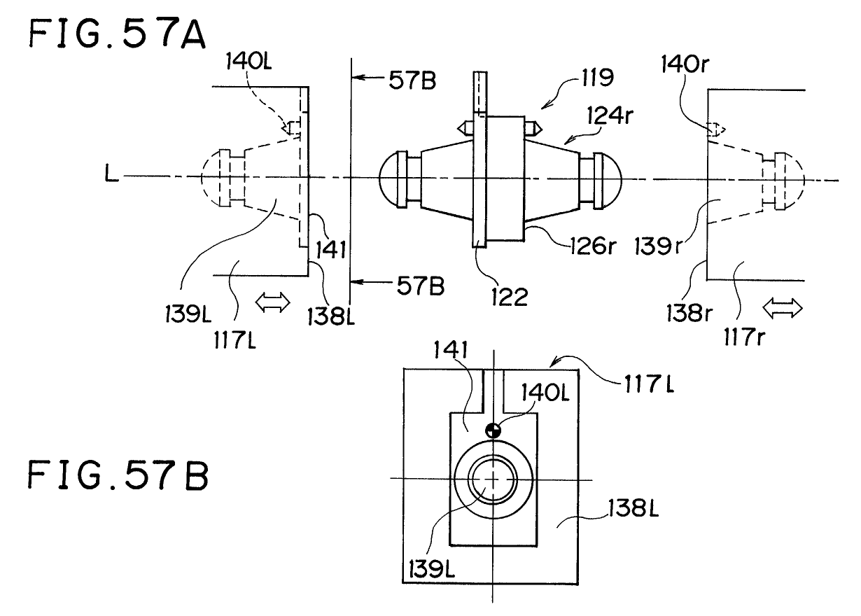

The construction of the main shafts 117r, 117l will be described with reference to FIGS. 57A and 57B. The main shafts 117r, 117l make a pair facing each other. With the winding frame 119 fitted, one of the main shafts 117r, 117l rotates to wind the element wire 2. With an aligning cup fitted, the other main shaft defines the winding position of the element wire 2 for every turn by rotating in the same phase and at the same speed as the other main shaft with the winding frame 119 while moving toward the other main shaft with the winding frame 119 by an amount substantially equal to the width of the element wire 2 at a time. First, a construction common to the right-side main shaft 117r and the left-side main shaft 117l will be described. The main shafts 117r, 117l can be rotated about the axis L in FIG. 57A in synchronous phase and at equal speeds by drive mechanisms (not shown) and, further, can be moved in directions indicated by arrows in FIG. 57A by drive mechanisms (not shown). The construction of each of the main shafts 117r, 117l will be described separately. The right-side main shaft 117r is designed to receive, from an end surface 138r thereof, the male chuck taper 131 of an odd number-layer aligning cup 128 or the male chuck taper 124r of the winding frame 119 extending from the end surface 126r remote from the shoulder portion 122 of the winding frame 119. That is, the right-side main shaft 117r has a female chuck taper (recessed structure) 139r for receiving the male chuck taper 124r of the winding frame 119 or the male chuck taper 131 of an odd number-layer aligning cup 128, and a phase defining pin receptacle 140r for receiving the phase defining pin 123r of the winding frame 119 or the phase defining pin 130 of an odd number-layer aligning cup 128 to define the mounting position of the winding frame 119 or the odd number-layer aligning cup 128. The left-side main shaft 117l has a similar construction, but differs from the right-side main shaft 117r in that an end surface 138l of the left-side main shaft 117l has a stepped recess 141 for receiving the shoulder portion 122 of the winding frame 119, including the retaining grooved projection 125. The stepped recess 141 has such a configuration, that is, a depth and other dimensions, that the shoulder portion 122, including the retaining grooved projection 125, is closely fitted thereinto, with the exposed end surface of the shoulder portion 122 being substantially flush with the end surface 138l of the left-side main shaft 117l. A female chuck taper 139l and a phase defining pin receptacle 140l extend into the left-side main shaft 117l from the bottom surface of the stepped recess 141.

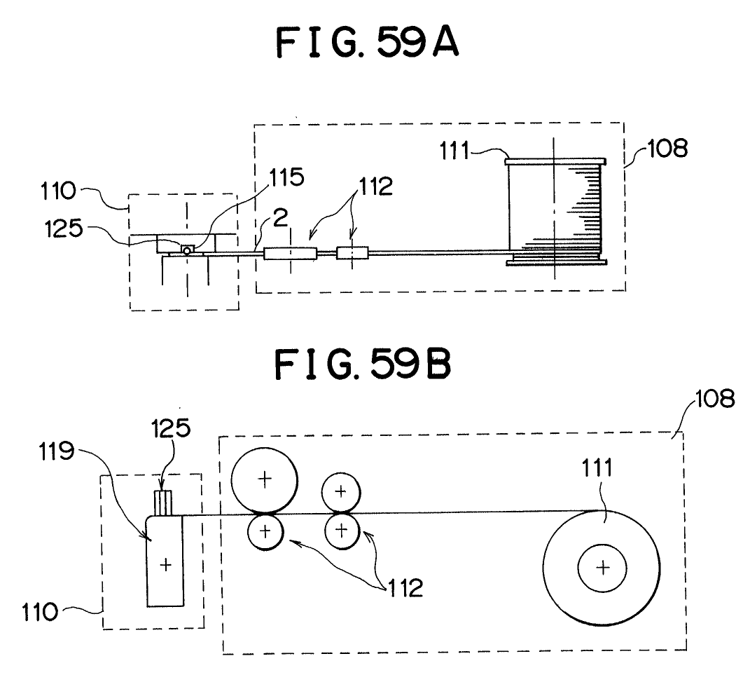

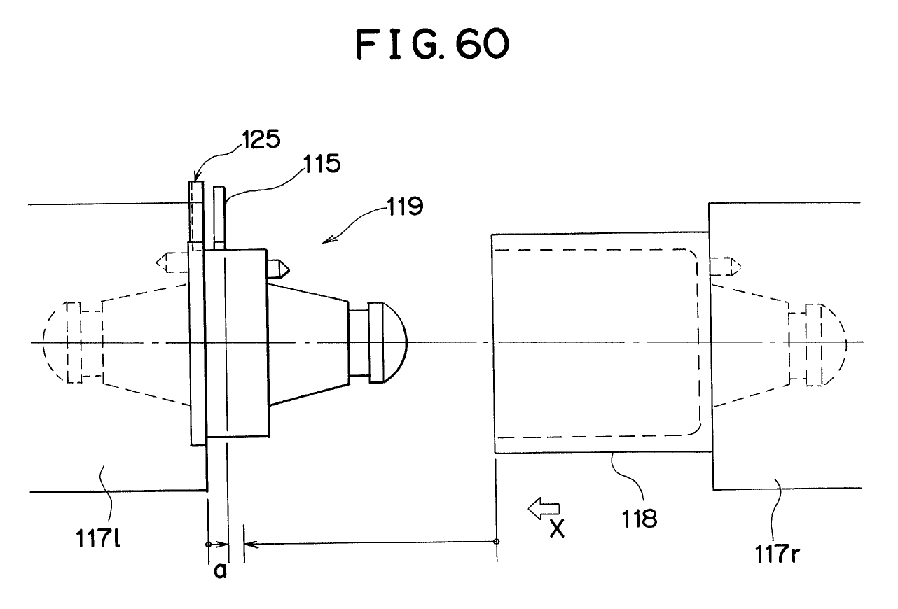

A winding method employed by the winding apparatus of this embodiment will be described with reference to FIGS. 51A, 51B and 58 through 65. As shown in FIGS. 51A and 51B, the element wire guide rollers 112 in the element wire supplying unit 108 guides a leading end of the element wire 2 toward the lead portion forming unit 109. When a length of a leading end portion of the element wire 2 that is needed to form the winding-start lead portion 115 is supplied into a gap between the forming dies 114a, 114b of the lead portion forming unit 109, the element wire guide rollers 112 temporarily stops guiding the element wire 2. Subsequently, the forming dies 114a, 114b are moved toward each other to press the element wire 2. The forming dies 114a, 114b press the leading portion of the element wire 2 as indicated in FIG. 57, thereby forming the winding-start lead portion 115 at the leading end of the element wire 2. After that, the forming dies 114a, 114b are moved apart from each other to release the element wire 2, and then further moved to such positions that the forming dies 114a, 114b do not interfere with the movement of the element wire supplying unit 108 toward the winding unit 110. The element wire supplying unit 108 is moved toward the winding unit 110 by a drive device (not shown) with the element wire guide rollers 112 remaining stopped, after the winding-start lead portion 115 of the element wire 2 has been formed. The movement of the element wire supplying unit 108 is stopped when the winding-start lead portion 115 reaches the retaining grooved projection 125 of the winding frame 119 as indicated in FIGS. 59A and 59B. Subsequently, the left-side main shaft 1171 is moved in a direction indicated by arrow “a” in FIG. 60, so that the winding-start lead portion 115 is inserted into the retaining grooved projection 125.

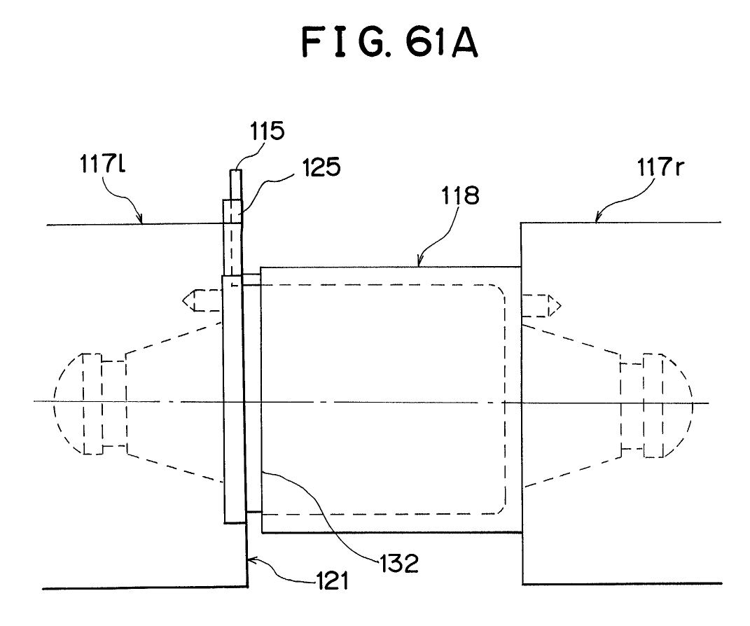

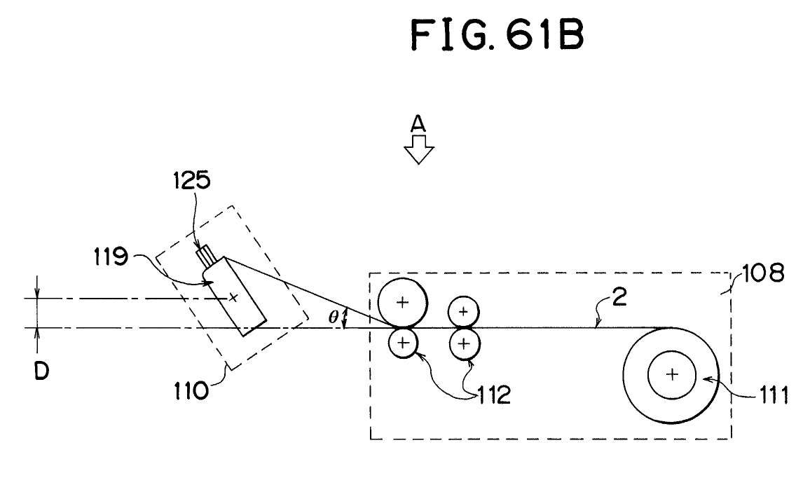

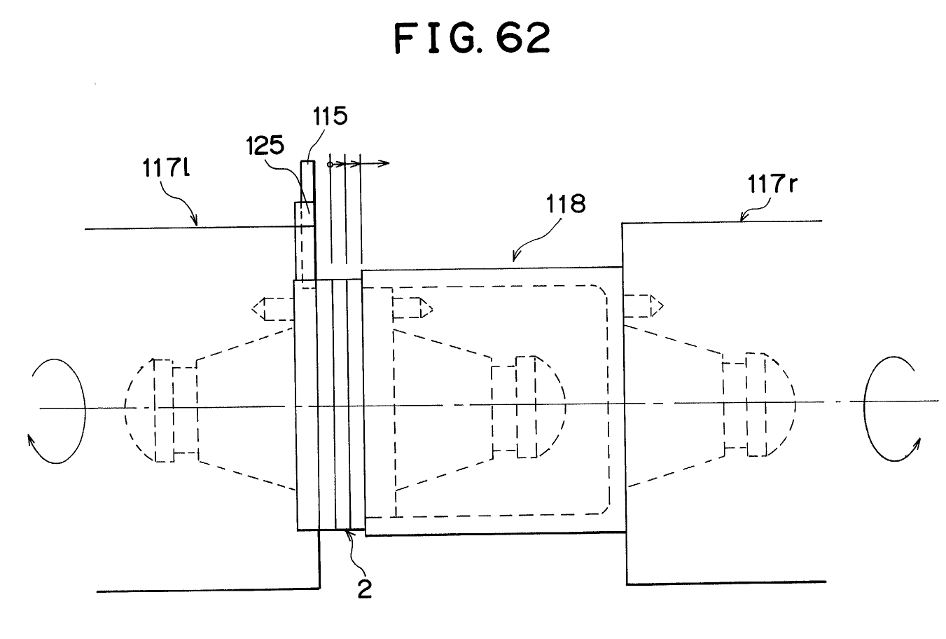

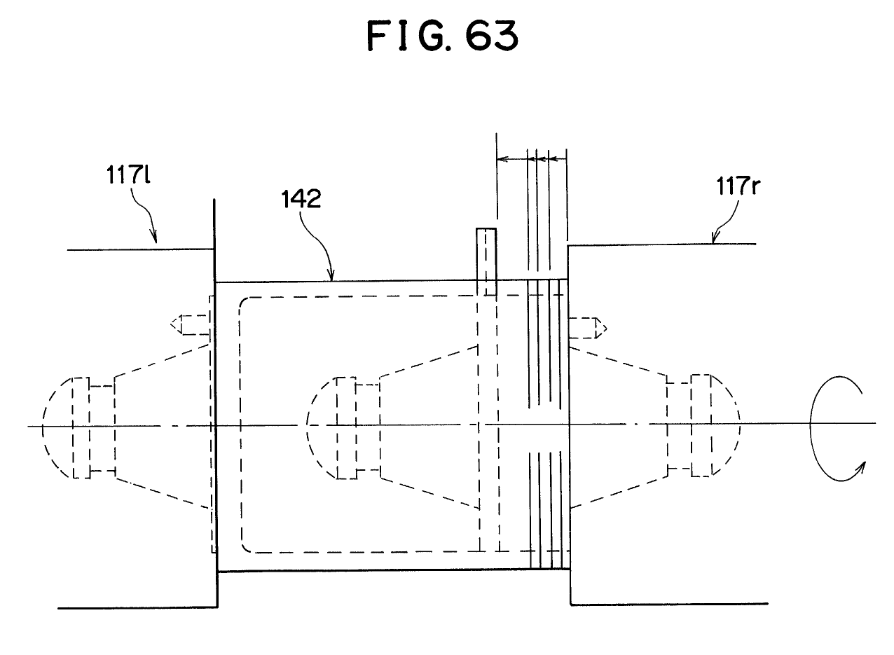

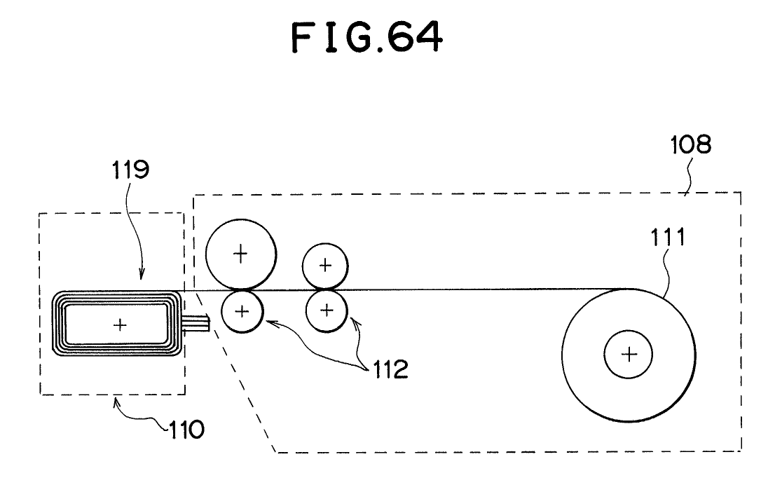

After the winding-start lead portion 115 is inserted into the retaining grooved projection 125, the right-side main shaft 117r with the first-layer aligning cup 118 fitted thereto is moved in a direction indicated by arrow X in FIG. 60. The right-side main shaft 117r is stopped at a position that is apart from the winding start reference surface 121 indicated in FIG. 61A by a distance substantially equal to the width of the element wire 2, so that a winding position of the element wire 2 for the first turn is defined by the retaining grooved projection 125 and the aligning surface 132 of the first-layer aligning cup 118 sandwiching the element wire 2. Subsequently, as indicated in FIG. 61B, the element wire supplying unit 108 is lowered in a downward direction in the FIG. 61B, thereby providing the element wire 2 with a feed angle θ. In this manner, an offset D is provided for providing the element wire 2 with a reverse curvature that prevents the element wire 2 wound on the winding portion 120 from lifting off the winding portion 120. While this positional relationship is maintained, the right-side main shaft 117r and the left-side main shaft 117l are started to rotate in synchronous phase and at equal speeds, thereby starting to wind the element wire 2. During the operation of winding the element wire 2, the element wire supplying unit 108 is moved in top-to-bottom directions in FIG. 51A by a drive device (not shown) so that a straight line passing through the element wire guide rollers 112 and the winding start point on the winding frame 119 substantially coincides with a straight line passing through the element wire guide rollers 112 and the element wire supply start point on the element wire reel 111, as indicated in FIGS. 59B and 64. FIG. 59A shows a view of the winding frame 119 and the aligning cup taken in a direction indicated by arrow A in FIG. 61B. Let it be assumed that the position of the retaining grooved projection 125 indicated in FIG. 59A is the original position of rotation. Every time the right-side main shaft 117r rotates clockwise to a three-quarter position from the original position, the right-side main shaft 117r is moved to increase the interval from the left-side main shaft 117l by an amount equal to the width of the element wire 2 as indicated in FIG. 62. Thereby, the winding position of the element wire 2 can be defined for every turn as the winding operation proceeds. When the winding of the element wire 2 for the last turn of the first layer proceeds to three quarters of the turn, the right-side main shaft 117r is moved in a direction of the axis thereof to such a position that the male chuck taper 124r of the winding frame 119 is completely out of the first-layer aligning cup 118. After the first-layer aligning cup 118 is removed from the right-side main shaft 117r, the right-side main shaft 117r is moved forward to fit onto the male chuck taper 124r of the winding frame 119. The winding frame 119 is then detached from the left-side main shaft 117l by moving back the left-side main shaft 117l, and a second-layer aligning cup 142 is fitted to the left-side main shaft 117l. The left-side main shaft 117l is then moved forward to such a position that the aligning surface 132′ of the second-layer aligning cup 142 reaches the position of the last turn of the first layer, which becomes the position of the first turn of the second layer. Then, the right-side main shaft 117r and the left-side main shaft 117l are rotated again in synchronous phase and at equal speeds to wind the element wire 2 on the winding frame 119 as indicated in FIG. 63. Every time the main shafts 117r, 117l rotate to the three-quarter rotational position from the original position, the right-side main shaft 117r is moved toward the left-side main shaft 117l along the axis thereof by an amount substantially equal to the width of the element wire 2, so that the winding position of the element wire 2 for every turn is defined by the second-layer aligning cup 142 on the left-side main shaft 117l. During the axial movement of the right-side main shaft 117r, the retaining grooved projection 125 of the winding frame 119 fitted to the right-side main shaft 117r moves through the groove or slit formed in a side wall of the second-layer aligning cup 142. For the third, fourth and outer layers, an odd number-layer aligning cup 128 and an even number-layer aligning cup 133 are fitted to or detached from the right-side main shaft 117r and the left-side main shaft 1171, respectively, with the winding frame 119 being switched between the main shafts 117r, 117l. In this manner, the winding position of the element wire 2 for every turn of each layer up to the outermost layer is defined on the winding progress side of the wire 2 by a suitable aligning cup.

When the element wire 2 is wound on the winding frame 119 to the three-quarter rotational position from the original position for the last turn of the last layer as indicated in FIG. 64, the element wire supplying unit 108 is moved to such a position as to secure a length of the element wire 2 needed to form a winding-end lead portion of the wire of the coil and a winding-start lead portion of the wire for the next coil to be formed, as shown in FIG. 65. By a drive device (not shown), the cutter 143 of the cutting unit is moved to a boundary between the winding-end lead portion of the wire of the coil presently formed and the winding-start lead portion of the wire of the next coil to be formed. At the boundary, the cutter 143 cuts the element wire 2. After that, the coil is removed from the winding frame 119. The production of the coil is thus completed. The element wire supplying unit 108 is moved back to the position indicated in FIGS. 51A and 51B, to produce another coil in the procedure as described above.

In this embodiment, the element wire supplying unit 108 is movable in the right-to-left, top-to-bottom and front-to-rear directions as indicated in FIGS. 51A and 51B, so that various advantages can be achieved. For example, since the element wire supplying unit 108 can be moved leftwards to the lead portion forming unit 109 before the element wire 2 is wound on the winding frame 119, the element wire 2 can be supplied to a predetermined press position between the forming dies 114a, 114b of the lead portion forming unit 109 without being bent. Therefore, the winding-start lead portion 115 can be formed with a high precision. Since after the winding operation, the element wire supplying unit 108 can be moved to such a position that a length of the element wire 2 for the winding-end lead portion of the wire of the coil formed and the winding-start lead portion 115 of the wire of the next coil to be formed, the cutting of the element wire 2 by using the cutter 143 of the cutting unit simultaneously accomplishes both the step of ending the winding operation and the step of preparing for production of the next coil. After the element wire supplying unit 108 is moved leftwards until the winding-start lead portion 115 formed at the leading end of the element wire 2 reaches the winding frame 119, the element wire supplying unit 108 can be moved in a top-bottom direction in FIG. 59B (front-rear direction). Therefore, the winding-start lead portion 115 can be automatically inserted into the retaining grooved projection 125 of the winding frame 119, as shown in FIG. 59A. Furthermore, while the element wire reel 111 is paying out the element wire 2, the element wire supplying unit 108 is moved up and down so that a straight line passing through the element wire guide rollers 112 and the winding start point on the winding frame 119 substantially coincides with a straight line passing through the element wire guide rollers 112 and the element wire supply start point on the element wire reel 111. Therefore, the element wire 2 can be prevented from bending before being wound on the winding frame 119.

Since the above-described position defining devices have a cup-like shape, each position defining device is able to cover the outer peripheral surfaces of the windings formed on the winding frame 119 while guiding the element wire 2 to the predetermined winding position. Therefore, the position defining devices in this embodiment can precisely guide the element wire 2 to the winding position while preventing the deviation or collapse of the windings.

The lead portion forming unit 109 automatically forms the winding-start lead portion 115 at the leading end of the element wire 2 before the element wire 2 is wound on the winding frame 119. Furthermore, the lead portion forming unit 109 is movable. That is, the lead portion forming unit 109 is moved to the element wire 2 to form the winding-start lead portion 115. After the formation of the winding-start lead portion 115 is completed, the lead portion forming unit 109 is moved to such a position that the lead portion forming unit 109 does not impede the movements of the element wire supplying unit 108. Thus, the lead portion forming unit 109 is able to automatically form the winding-start lead portion 115 at the leading end of the element wire 2 and avoid impeding the supply of the element wire 2.

Furthermore, in this embodiment, the winding frame 119 and a layer-specific aligning cup are respectively connected to the main shafts for rotating the winding frame 119 and the layer-specific aligning cup about the center axis thereof, by using one of the male chuck tapers 124r, 124l and one of the male chuck taper 131 (or 135) and the female chuck tapers 139r, 139l. Therefore, the winding frame 119 is fittable to either one of the right-side main shaft 117r and the left-side main shaft 117l. Since the aligning cups have identical male chuck tapers, the aligning cups are fittable to either one of the right-side main shaft 117r and the left-side main shaft 117l. That is, any aligning cup having a male chuck taper having substantially the same configuration as described above can be fitted to either one of the right-side main shaft 117r and the left-side main shaft 117l. If the element wire 2 is replaced by an element wire having a different shape, a coil can also be produced therefrom simply by preparing aligning cups and a winding frame that match the shape of the element wire. Therefore, various coils having different configurations can be produced.

Further, the winding frame 119 and the aligning cups are provided with the phase defining pins 123r, 123l, 130, 134, and the main shafts are provided with phase defining pin receptacles 140r, 140l. By fitting the phase defining pins 123r, 123l , 130, 134 into the phase defining pin receptacles 140r, 1401, the position of the winding frame 119 and an aligning cup to the main shafts in a rotational direction is defined, and the position is also fixed so that the winding frame 119 and the aligning cup rotate together with the main shafts without a positional deviation in the rotational direction. Since each even number-layer aligning cup 133 is provided with the groove (or slit) 136 corresponding to the retaining grooved projection 125 of the winding frame 119, an even number-layer aligning cup 133 fitted to the left-side main shaft 117l and the winding frame 119 fitted to the right-side main shaft 117r can be moved relative to each other in the directions of the axis thereof, without a problem.

Further, in the operation of winding the element wire 2 on the winding frame 119, the winding frame 119 is switched between the right-side main shaft 117r and the left-side main shaft 117l, and at least one of the main shafts that holds the winding frame 119 is rotated. Therefore, it becomes possible to wind the element wire 2 on the winding frame 119 in a plurality of layers. Further, the retaining grooved projection 125 is formed at an end of the winding portion 120 of the winding frame 119. Before the winding is started, the winding frame 119 is connected to one of the main shafts by the male chuck taper formed on the side of the retaining grooved projection 125, and the first-layer aligning cup 118 is connected to the other main shaft. Therefore, it becomes possible to define the winding position of the element wire 2 on the winding progress side during the winding of the first layer. After the winding of the first layer, the winding frame 119 is switched to the other main shaft after the aligning cup has been removed therefrom, and the second-layer aligning cup is fitted to the main shaft that held the winding frame 119 during the first-layer winding. Therefore, for the second layer winding, too, the winding position of the element wire 2 can be defined on the winding progress side. By performing a similar procedure for every layer shift, the winding position of the element wire 2 can be defined on the winding progress side for all the layers.

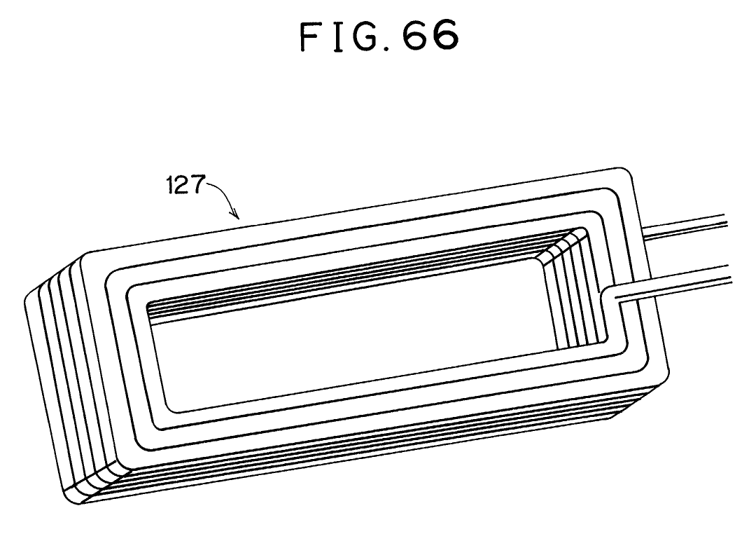

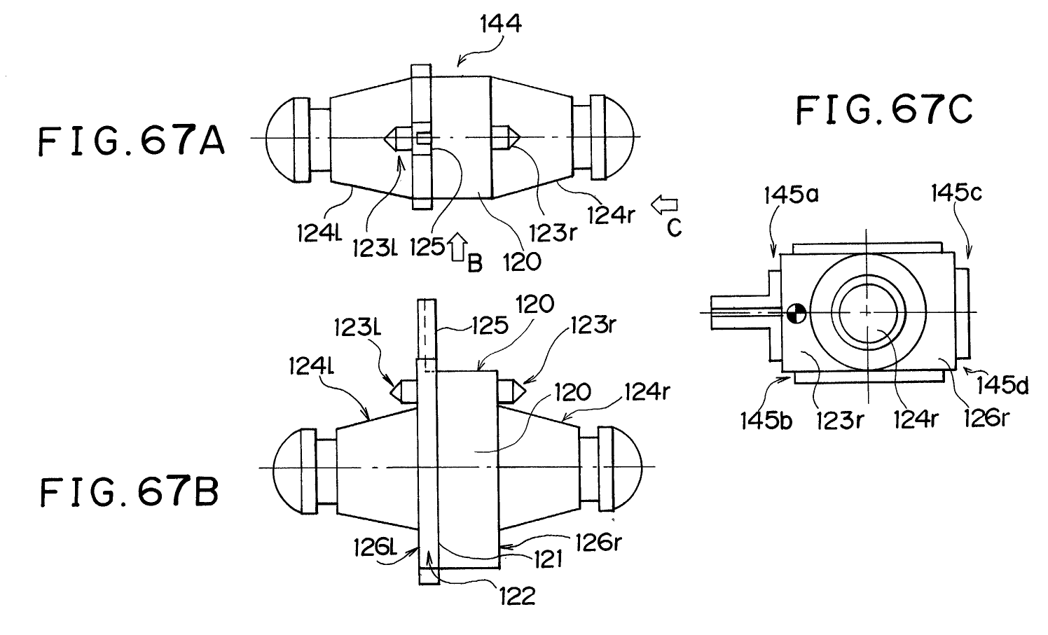

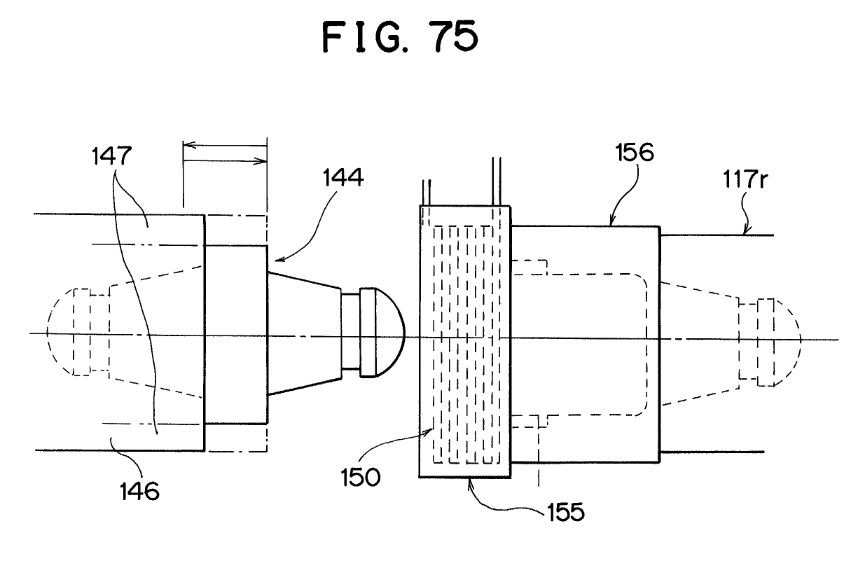

A sixth embodiment of the invention will be described with reference to FIGS. 67A through 75.

This embodiment is substantially the same as the fifth embodiment, except that the winding frame and the left-side main shaft are partly different from the counterparts of the fifth embodiments. Constructions distinguishing the sixth embodiment from the fifth embodiment will be described below. As can be seen from FIGS. 67A, 67B and 67C, a winding frame 144 in this embodiment has a construction similar to that of the winding frame 119 in the fifth embodiment. That is, the winding frame 144 has a four-sided winding portion 120, a shoulder portion 122 that forms a winding start reference surface 121, phase defining pins 123r, 1231, male chuck tapers 124r, 1241, and a retaining grooved projection 125 for retaining a winding-start lead portion 115. The winding frame 144 of this embodiment differs from the winding frame 119 of the fifth embodiment in that each of the four corners of the winding portion 120 has an escape portions 145a-145d through which push-out rods (described later) pass.

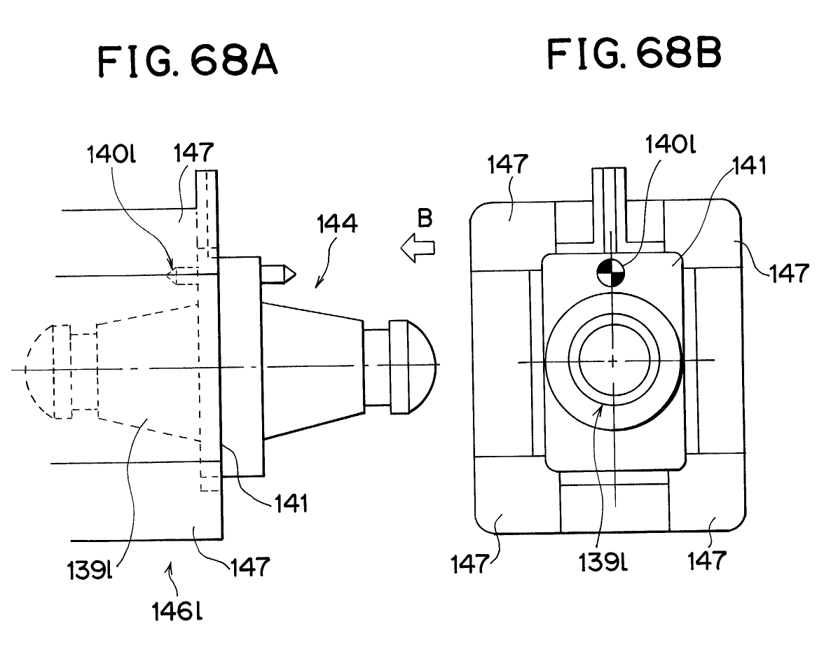

The construction of the left-side main shaft will be described. As shown in FIGS. 68A and 68B, a left-side main shaft 146 of this embodiment has a construction similar to that of the left-side main shaft 1171 of the fifth embodiment. That is, the left-side main shaft 146 has a female chuck taper (recessed structure) 1391, a phase defining pin receptacle 1401, and a stepped recess 141. The left-side main shaft 146 of this embodiment differs from the left-side main shaft 1171 of the fifth embodiment in that each of the four corners of the left-side main shaft 146 is provided with a push-out rod 147. The four push-out rods 147 are thrust out to the same length in synchronous phase at equal speeds, in the same direction. The push-out rods 147 are thrust out by at least an amount equal to the width of the winding portion 120 of the winding frame 144, toward the right-side main shaft 117r, as described below, in order to detach a coil 150 from the winding frame 144 after the winding operation is completed.

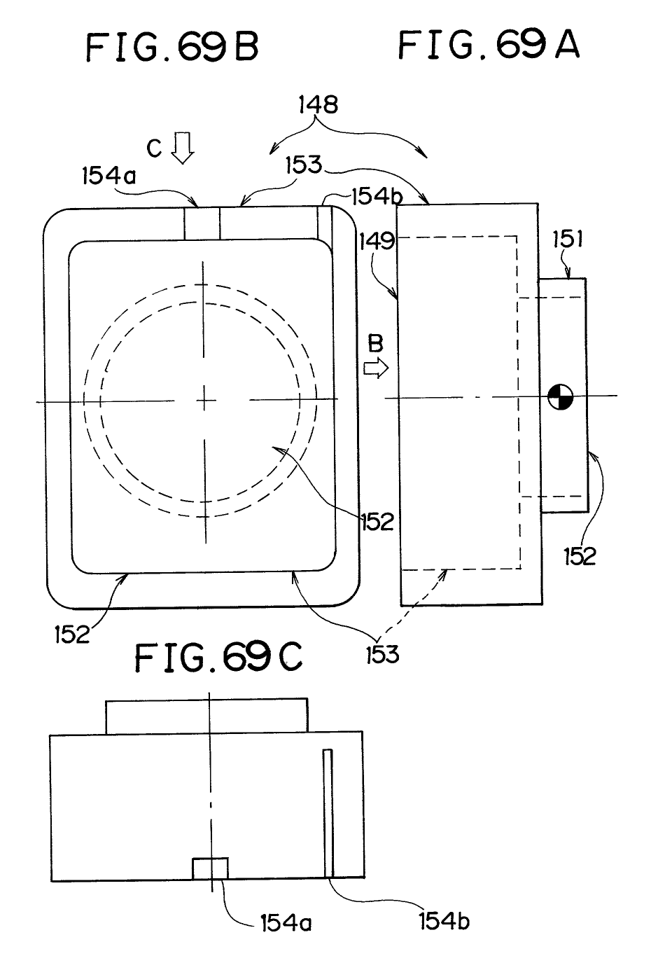

A coil holder 148, that is, a feature of the sixth embodiment, will now be described with reference to FIGS. 69A, 69B and 69C. The coil holder 148 is a generally rectangular tubular member having hold surfaces 153 that are formed by inner side surfaces so as to cover the outer peripheral surfaces of windings 150 wound on the winding portion 120 of the winding frame 144. The tubular coil holder 148 has a full-opening edge 149 at one end thereof. The opposite end of the coil holder 148 is provided with a male chuck portion 151 for coupling to an adapter described below. The male chuck portion 151 has a through-hole 152 that has such a size that the male chuck taper 124r of the winding frame 144 can extend therethrough. The full-opening edge 149 has a first groove 154a into which the retaining grooved projection 125 of the winding frame 144 can fit, and a second groove 154b into which a terminal end portion 155 of the winding 150 can fit.

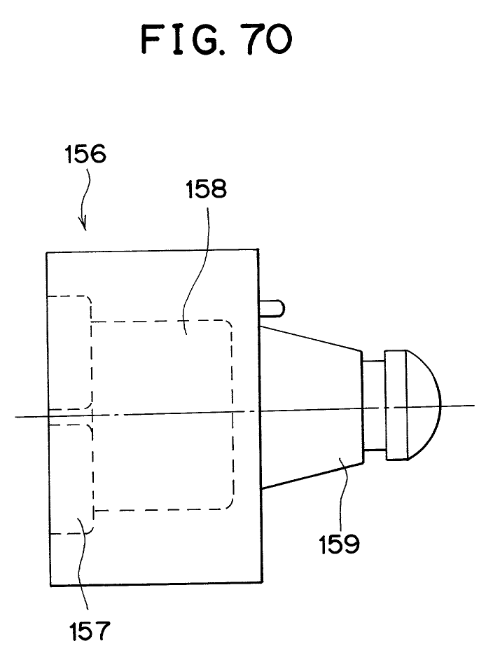

The adapter is used to fit the coil holder 148 to the right-side main shaft 117r. As shown in FIG. 70, the adapter 156 has at one end thereof a female chuck portion 157 for receiving therein the male chuck portion 151 of the coil holder 148, and has at the opposite end thereof a male chuck taper 159 for the coupling of the adapter 156 to the right-side main shaft 117r. A space 158 is formed inwardly of female chuck portion 157. The space 158 receives the male chucking taper 124r of the winding frame 144 protruding from the through-hole 152 of the coil holder 148 when the coil holder 148 coupled with the adapter 156 is fitted to the winding frame 144.

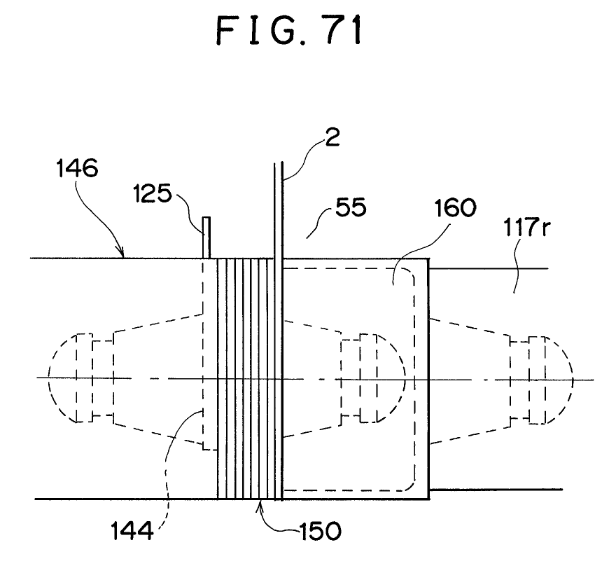

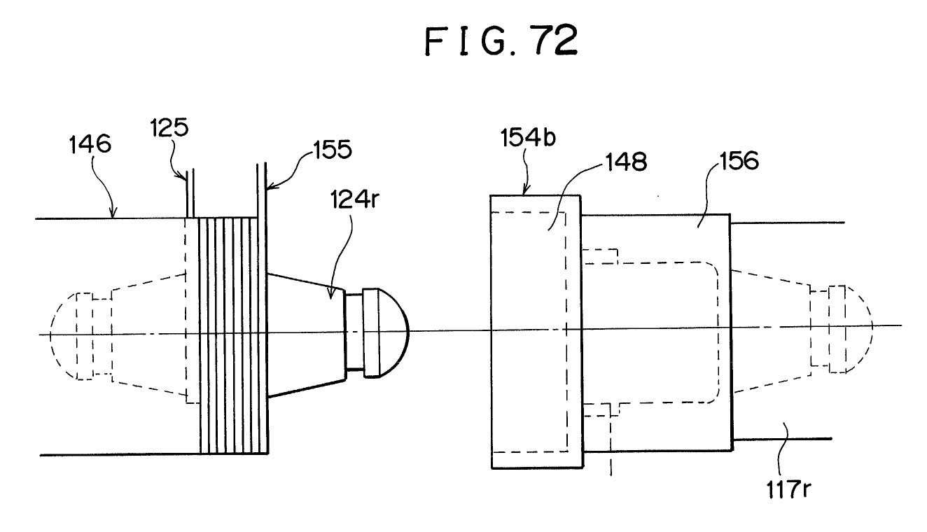

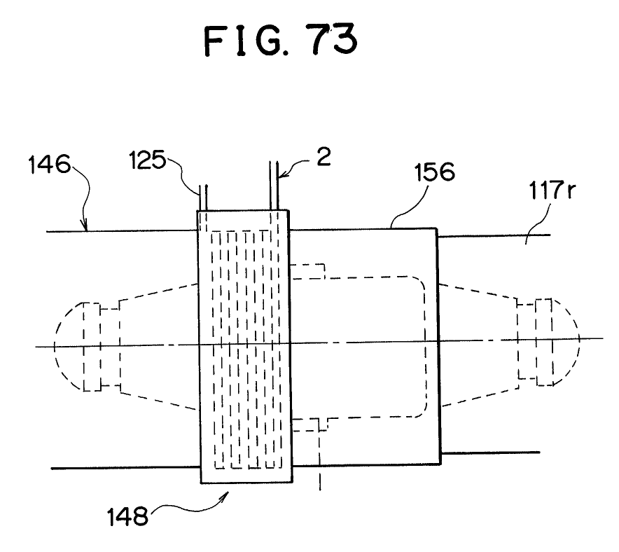

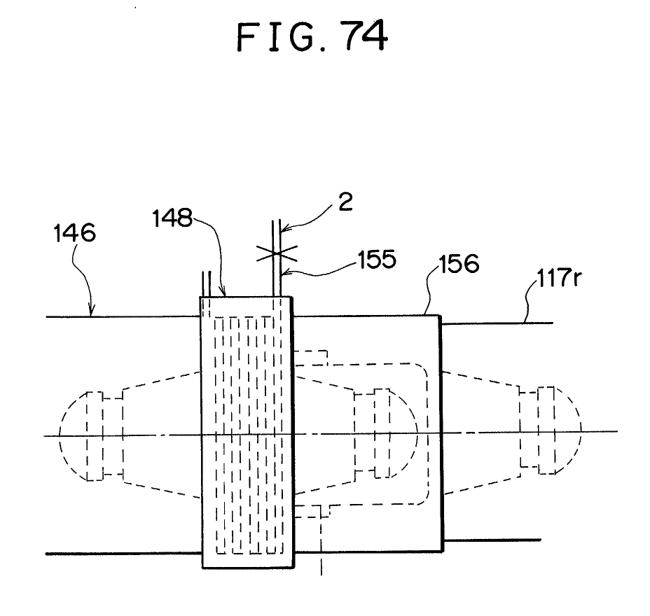

The operation performed by the winding apparatus to remove the coil 150 from the winding frame 144 will be described with reference to FIGS. 71 through 75. When the element wire 2 has been completely wound for the last layer on the winding frame 144 fitted to the left-side main shaft 146 by using a last-layer aligning cup 160 fitted to the right-side main shaft 117r to define the winding position of the element wire 2 as shown in FIG. 71, the right-side main shaft 117r is moved rightwards in FIG. 71 to a predetermined position. After the right-side main shaft 117r has reached the predetermined position, the last-layer aligning cup 160 is removed from the right-side main shaft 117r, and the adapter 156 coupled with the coil holder 148 is fitted to the right-side main shaft 117r. The adapter 156 and the coil holder 148 have been coupled in such a positional relationship that the first grooves 154a and the second groove 154b of the coil holder 148 can receive therein the retaining grooved projection 125 of the winding frame 144 fitted to the left-side main shaft 146 and the terminal end portion 155 of the coil 150, respectively. The aforementioned predetermined position of the right-side main shaft 117r is set on the basis of such a position that the male chucking taper 124r of the winding frame 144 fitted to the left-side main shaft 146 does not impede the operation of connecting the coil holder 148 to the right-side main shaft 117r. After the coil holder 148 is connected to the right-side main shaft 117r via the adapter 156 as shown in FIG. 72, the right-side main shaft 117r is moved toward the left-side main shaft 146 so that the coil holder 148 covers the coil 150 as shown in FIG. 73. When the coil 150 is covered by the coil holder 148, the retaining grooved projection 125 of the winding frame 144 and the terminal end portion 155 of the coil 150 fit into the first groove 154a and the second groove 154b, respectively. Subsequently, the element wire 2 is cut at an appropriate position in the terminal end portion 155 as shown in FIG. 74. After that, the right-side main shaft 117r is moved away from the left-side main shaft 146 (to the right in FIG. 74), and the push-out rods 147 are thrust out rightwards from the left-side main shaft 146 synchronously with the movement of he right-side main shaft 117r. Therefore, the coil 150 is pushed and separated from the winding frame 144 by the push-out rods 147 so that the coil 150 is transferred into the interior space of the coil holder 148.

According to the sixth embodiment, the left-side main shaft 146 for holding the winding frame 144 is provided with the push-out rods 147 disposed inwardly of the outer periphery of the shoulder portion 122 of the winding frame 144. After the winding of the element wire 2 for the last layer is completed, the push-out rods 147 are thrust out from the left-side main shaft 146 to remove the coil 150 from the winding frame 144. For this coil removing process, the coil holder 148 fitted to the right-side main shaft 117r covers the coil 150 formed on the winding frame 144. Synchronously with the movement of the push-out rods 147, the right-side main shaft 117r is moved so that the coil 150 is transferred into the coil holder 148. Thus, it becomes possible to remove the coil 150 from the winding frame 144 while preventing disintegration of the coil 150 due to spring-back involved in the cutting of the coil terminal end portion of the element wire 2.

Although in the fifth and sixth embodiments, the winding of the element wire 2 is started from the side of the left-side main shaft, the winding of the element wire 2 may also be started from the side of the right-side main shaft, if a winding start reference surface is provided toward a side of the winding frame, that is, the side corresponding to the right-side main shaft, and the winding frame is fitted to the right-side main shaft.

According to the invention, the winding supplying section is relatively rotated around the winding portion. As long as the winding position defined by a position defining device (corresponding to the box members in the first embodiment, the position defining roller in the second and third embodiments, and the guide device in the fourth embodiment) for defining the winding position of the element wire on the winding progress side, is moved as the winding on the winding portion progresses, either one of the wire supplying device and the winding portion or both of them may be rotated.

While the present invention has been described with reference to what are presently considered to be preferred embodiments thereof, it is to be understood that the invention is not limited to the disclosed embodiments or constructions. To the contrary, the invention is intended to cover various modifications and equivalent arrangements included within the spirit and scope of the invention.

What is claimed is:

1. A winding apparatus for winding an element wire around a winding portion, comprising:
a supplier that supplies the element wire;
a guide that guides the element wire to a predetermined winding position;
a controller that, in a winding layer around the winding portion, defines the predetermined winding position of the element wire guided by the guide, on a side of the element wire, the side facing in a direction of winding progress along an axis of the winding portion; and
a mover that moves the controller synchronously with a movement of the predetermined winding position.

2. A winding apparatus according to claim 1, further comprising:
an attachment device that enables attachment and detachment of the controller, the attachment device being provided in the guide; and
means for holding one end portion of opposite end portions of the winding portion, the one end portion being rearward in the direction of winding progress, and for transmitting to the one end portion of the winding portion a torque around the axis of the winding portion,
the guide moving the attachment device synchronously with the movement of the predetermined winding position.

3. A winding apparatus according to claim 1, wherein the controller is disposed so that a central axis of the controller lies coaxially with the winding portion, and the controller has a generally cup shape such that the controller covers the winding portion from the winding progress side.

4. A winding apparatus according to claim 1, further comprising:
a lead portion former which is disposed on an element supplying path extending from the supplier and the winding portion, and which forms a winding-start lead portion at a leading end of the element wire before the element wire is supplied from the supplier to the winding portion; and
a connecting device that connects the winding-start lead portion to the winding portion.

5. A winding apparatus according to claim 1, further comprising:
a drawer that draws a length of the element wire from the supplier, the length being substantially equal to a sum of a predetermined length needed to form a winding-end lead portion and a length needed to form a winding-start lead portion for a next winding; and
a cutter that cuts the element wire at a position in the length of the element wire drawn by the drawer, the position corresponding to the predetermined length needed to form the winding-end lead portion.

6. A winding apparatus according to claim 1, further comprising:
a movable piece capable of moving a winding wound around the winding portion, in a direction of the axis of the winding portion;
a protector member which is disposed so that a central axis thereof lies substantially parallel to a central axis of the winding, and which is capable of covering the winding portion except at least a portion of the winding portion corresponding to a moving path of the movable piece;
a protector member moving device which, as the movable piece is moved, moves the protector member in a direction substantially the same as the moving direction of the movable member.

7. A winding apparatus for winding an element wire around a winding portion, comprising:
a supplier that supplies the element wire;
a guide that guides the element wire to a predetermined winding position on the winding portion;
a winder that winds the element wire at the predetermined position; and
restricting members provided in the guide so that the restricting members sandwich the predetermined position, and face each other in a direction of an axis of the winding portion, an interval between the restricting members being substantially equal to a width of the element wire,
wherein the element wire passes between the restricting members.

8. A winding apparatus for winding an element wire around a winding portion, comprising:
a reel that carries a winding wound around an axis substantially parallel to an axis of the winding portion; and
a winder that winds the element wire at a predetermined position on the winding portion,
wherein a winding direction of the element wire wound around the reel is the same as a winding direction of the element wire wound by the winder.

9. A winding apparatus for winding an element wire around a winding portion, comprising:
a supplier that supplies the element wire;
a controller that revolves the supplier around the winding portion; and
a rotating member which is disposed within a range of revolution of the supplier around the winding portion, and which is rotated by the controller in a phase different from a phase of the supplier.

10. A winding apparatus according to claim 9, wherein the rotating member aligns a winding through an action on an outer periphery of the winding portion.

11. A winding apparatus for winding an element wire around a winding portion, comprising:
a supplier that supplies the element wire;
a guide which protrudes from an outward point toward an inward point in an approaching direction to an outer peripheral surface of the winding portion, and which guides the element wire to a predetermined winding position on the winding portion;
a circumferential mover that moves the guide in a direction substantially perpendicular to the axis of the winding portion; and
an axial mover that moves the guide in a direction of the axis of the winding portion.

12. A winding apparatus according to claim 11, wherein the winding portion has, at an end portion thereof in a direction of the axis of the winding portion, a protrusion which protrudes in a direction substantially perpendicular to the axis of the winding portion, and which is movable in a direction of the axis thereof.

13. A winding apparatus for winding an element wire around a winding portion, comprising:
a reel that carries a winding wound around an axis substantially parallel to an axis of the winding portion;
a guide which protrudes from an outward point toward an inward point in an approaching direction to an outer peripheral surface of the winding portion, and which guides the element wire to a predetermined winding position on the winding portion;
a winder that winds the element wire at a predetermined position on the winding portion;
a controller that, in a winding layer around the winding portion, defines the predetermined winding position of the element wire guided by the guide, on a side of the element wire, the side facing in a direction of winding progress along the axis of the winding portion; and
a mover that moves the controller synchronously with a movement of the predetermined winding position,
wherein a winding direction of the element wire wound around the reel is the same as a winding direction of the element wire wound around the winding portion by the winder.

14. A winding apparatus according to claim 1, further comprising:
an attachment device that enables attachment and detachment of the controller, the attachment device being provided in the guide; and
a holder that holds one end portion of opposite end portions of the winding portion, the one end portion being rearward in the direction of winding progress, and for transmitting to the one end portion of the winding portion a torque around the axis of the winding portion,
the guide moving the attachment device synchronously with the movement of the predetermined winding position.
